(19) United States
(12) Patent Application Publication
(10) Pub. No.: US 2018/0300023 A1
(43) Pub. Date: Oct. 18, 2018

(54) METHODS, APPARATUSES, AND SYSTEMS FOR MATERIAL COATING SELECTION OPERATIONS

(71) Applicants: Christine HEIN, Atlanta, GA (US); HOME DEPOT PRODUCT AUTHORITY, LLC, Atlanta, GA (US)

(72) Inventor: Christine Hein, Atlanta, GA (US)

(21) Appl. No.: 15/768,742

(22) PCT Filed: Oct. 30, 2015
(86) PCT No.: PCT/US15/58387

§ 371 Date: Apr. 16, 2018

(51) Int. Cl. G06F 3/0482; G06Q 30/06

(52) U.S. Cl. CPC G06F 3/0482; G06Q 30/0621; G06Q 30/0643

(57) ABSTRACT

Methods, apparatuses, systems, and implementations of an online color platform are disclosed. At least some versions of the disclosed systems enable a user to find desirable paint and other material coatings suitable for the user's needs and interests. The disclosed systems may enable a user to navigate hierarchical menus, make various category selections, and view illustrative modifiable images to find and select suitable material coating items for purchase.

### BACKGROUND

### 1. Field of the Invention

This disclosure relates generally to methods, apparatuses, and systems that can be used to browse and select paint colors or other types of material coatings such as stains and varnishes.

### 2. Description of Related Art

Prior paint color selection applications may not have a capability to allow a user to find a desired paint color without conducting a time-consuming search through a long list of colors. Additionally, prior paint color selection applications may not have a capability to adequately portray to the user how a particular color may look in a particular room or setting.

### SUMMARY

This disclosure includes embodiments of methods, apparatuses, and systems for online material coating lookup and purchase operations. In some embodiments, the online material coating lookup can be used by a customer to find specific paint colors or material coatings in an inventory for a customer to purchase. This functionality may be especially useful in situations where the user may not know a particular color or type of material coating suitable for his needs.

Some embodiments of the system may initiate a session of an online coating material application (an example of which is an online color application) by receiving a user input on a user interface running or stored on a hardware device comprising at least one processor. In some embodiments, the user interface may enable the display on a user hardware device of one or more of a plurality of first selectable options including one or more of an interior coating exploration option; an exterior coating exploration option; and a project exploration option. In some embodiments, the user interface may enable the display on a user hardware device of a plurality of second selectable options including one or more of a color style option, a color expert option, a color purpose option, a color room option, a color object option, and a color browse option. The system may receive a user selection of one of the options to enable the display on a user hardware device of a hierarchical menu including selectable categories relating to the option the user selected. The user may then select one of the categories. In some embodiments, the system may enable the display on a user hardware device of one or more selectable material coating color options relating to the category the user selected. The system may then receive a user selection of one of the material coating color options. In some embodiments, the system may enable the display on a user hardware device of an image showing a sample environment coated in the material coating color option selected by the user. In some embodiments, the system may enable the display on a user hardware device of a checkout link to the user that enables the user to purchase one or more of the material coatings.

In some embodiments, the system may modify the image, such as to change a material coating color upon receipt of a subsequent user selection of another coating color option The terms “modify” and “modified” (and derivatives thereof) are broad. As a result, in some embodiments, a modification involves a change to the original image, resulting in a modified image; in other embodiments, a modification involves replacement of the original image with another image, which, again, results in a modified image (as that term is used in this disclosure). Thus, a “modified” image can have (or be represented by) some or none of the data of the image that has been modified; however, a modified image may have one or more features that appear the same as corresponding one or more features of the image that has been modified.

In some embodiments, the system, after receiving a user selection of a color style option, may enable the display on a user hardware device of one or more selectable decorative themes. The system may then receive a user selection of one of the decorative themes. In some embodiments, the system may enable the display on a user hardware device of a plurality of selectable material coating color options, color palettes, and color ideas based on the selected decorative theme.

In some embodiments, the system, after receiving a user selection of a color expert option, may enable the display on a user hardware device of one or more selectable expert names. The system may then receive a user selection of one of the expert names. In some embodiments, the system may enable the display on a user hardware device of a plurality of selectable material coating color options, color palettes, and color ideas based on at least one recommendation of an expert corresponding to the selected expert name.

In some embodiments, the system, after receiving a user selection of a color purpose option, may enable the display on a user hardware device of one or more selectable decorating purposes. The system may then enable a user selection of one of the decorating purposes. In some embodiments, the system may enable the display on a user hardware device a plurality of selectable material coating color options, color palettes, and color ideas based on the selected decorating purpose.

In some embodiments, the system, after receiving a user selection of a color room option, may enable the display on a user hardware device of one or more selectable room categories. The system may then enable a user selection of one of the room categories. In some embodiments, the system may then enable the display on a user hardware device of a plurality of room images corresponding to the selected room category.

In some embodiments, the system may enable the display on a user hardware device of a selectable color menu comprising a plurality of color categories. The system may then receive a user selection of one of the color categories listed in the selectable color menu. In some embodiments, the system may enable the display on a user hardware device of a modified plurality of room images having a color scheme corresponding to the selected color category. The system may then enable a user selection of one of the modified room images. In some embodiments, the system may then enable the display on a user hardware device of a plurality of selectable material coating color options, color palettes, and color ideas based on the selected modified room image.

In some embodiments, the system may enable the display on a user hardware device of one or more selectable objects having preset color schemes. The system may then receive a user selection of one of the selectable objects and select a color inquiry or a project inquiry. In some embodiments, the system may enable the display on a user hardware device of a plurality of selectable material coating color options, color palettes, and color ideas based on the preset color scheme of the selected selectable object. In some embodiments, the system may enable the display on a user hardware device of an interactive project interface comprising construction instructions for creating an object corresponding to the selected selectable object.

In some embodiments, the system may enable the display on a user hardware device of one or more selectable color categories. The system may then enable a user selection of one of the color categories. In some embodiments, the system may then enable the display on a user hardware device of one or more selectable color shades based on the selected color category. In some embodiments, the system may then enable the display on a user hardware device of the image and a plurality of selectable material coating color options, color palettes, and color ideas based on the selected color shade.

In some embodiments, the plurality of selectable color options may be arranged in a carousel format in an order of lighter to darker color shade, the selectable color options comprising one or more scroll buttons. In some embodiments, the system may enable the image to be modified to display a color corresponding to a user selection of one of the plurality of color options.

In some embodiments, the system may enable the display on a user hardware device of a material coating option. The system may then receive a user selection of a room type to be coated. In some embodiments, the system may then enable the display on a user hardware device of a list of material coating attributes corresponding to the selected room type. The system may then receive a user selection of one or more material coating attributes. In some embodiments, the system may then enable the display on a user hardware device of a list of material coatings exhibiting the selected material coating attribute.

In some embodiments, the system may enable the display on a user hardware device of a material coating sheen option comprising a list of sheens and sheen attributes corresponding to the selected color option. The system may then receive a user selection of a sheen from among the list of sheens, where the list of sheens is arranged in an order of matte to shiny sheens.

The system may then receive a user selection of a checkout link. In some embodiments, the system may then enable the display on a user hardware device of one or more material coating brand options and corresponding pricing information. The system may then receive a user selection of one of the material coating brand options and a desired unit amount to purchase. In some embodiments, the system may then enable the display on a user hardware device of a shopping cart containing the desired unit amount of the selected material coating brand that enables the user to complete a purchase transaction.

In some embodiments, a computing system for implementing an online material coating application (an example of which is an online color application) may include a memory device and at least one processor configured to enable the display of a graphical user interface (GUI) including one or more graphical elements configured to implement, using the at least one processor, one or more software applications are stored on one or more servers. In some embodiments, the one or more software applications are configured to initiate a session of an online color application by receiving a user input on a user interface running or stored on a hardware device comprising at least one processor. In some embodiments, the software applications are further configured to enable the display of a plurality of selectable options comprising one or more of a color style option; a color expert option; a color purpose option; a color room option; a color object option; and a color browse option. In some embodiments, the software applications are further configured to receive, at the hardware device, data representing a user selection of one of the one or more selectable options and enable the display of a hierarchical menu comprising selectable categories relating to the user selection. In some embodiments, the software applications are further configured to receive, at the hardware device, data representing a user selection of a category from among the selectable categories and enable the display of one or more selectable material coating color options relating to the user selection of the category. In some embodiments, the software applications are further configured to receive, at the hardware device, data representing a user selection of one of the one or more selectable material coating color options and enable the display of an image showing a sample environment coated in the selectable material coating color option selected by the user, where the image is modified to change a material coating color based on a subsequent user selection of another of the one or more selectable coating color options. In some embodiments, the software applications are further configured to enable the display of a checkout link to the user that enables the user to purchase one or more material coatings corresponding to one or more of the one or more selectable coating color options.

In some embodiments, a non-transitory computer-readable medium may store a program comprising instructions executable by a machine to initiate a session of an online material coating application (an example of which is an online color application) by receiving a user input on a user interface running or stored on a hardware device including at least one processor and enabling the display of a plurality of selectable options including one or more of: a color style option; a color expert option; a color purpose option; a color room option; a color object option; and a color browse option. In some embodiments, the instructions are further executable to receive, at the hardware device, data representing a user selection of one of the one or more selectable options and enable the display of a hierarchical menu comprising selectable categories relating to the user selection. In some embodiments, the instructions are further executable to receive, at the hardware device, data representing a user selection of a category from among the selectable categories and enable the display of one or more selectable material coating color options relating to the user selection of the category. In some embodiments, the instructions are further executable to receive, at the hardware device, data representing a user selection of one of the one or more selectable material coating color options and enable the display of an image showing a sample environment coated in the one or more selectable material coating color option selected by the user, where the image is modified to change a material coating color based on a subsequent user selection of another of the one or more selectable coating color options. In some embodiments, the instructions are further executable to enable the display of a checkout link to the user that enables the user to purchase one or more material coatings corresponding to one or more of the one or more selectable coating color options.

In some embodiments, a computing system may implement an online coating material application (an example of which is an online color application), the computing system including a memory device and at least one processor configured to enable the display of a graphical user interface (GUI) including one or more graphical elements configured to implement, using the at least one processor, one or more software applications stored on one or more servers. In some embodiments, the one or more software applications may be configured to initiate a session of an online coating material application by receiving a user input on a user interface running or stored on a hardware device comprising at least one processor and enable the display on a user hardware device of one or more of a plurality of selectable options. In some embodiments, the plurality of selectable options may include one or more of: a live view option; a photo taking option; a photo loading option; a color matching option; a color searching option; and a tutorial option. In some embodiments, the one or more software applications may be configured to receive, at the hardware device, data representing a user selection of one of the one or more selectable options; enable the display on a user hardware device of one or more coating material options based on the data representing a user selection of one of the one or more selectable options; enable the display on a user hardware device of a share option; enable the display on a user hardware device of a save option; enable the display on a user hardware device of a checkout option that enables a user to purchase one or more material coatings corresponding to the one or more coating material options.

Also disclosed in the context of the present invention are embodiments 1 to 46. Embodiment 1 is a method of implementing an online coating material application, the method comprising: initiating a session of an online coating material application by receiving a user input at a hardware device comprising at least one processor; enabling the display on a user hardware device of one or more of a plurality of first selectable options comprising one or more of: an interior coating exploration option; an exterior coating exploration option; and a project exploration option; enabling the display on a user hardware device of one or more of a plurality of second selectable options comprising one or more of: a color style option; a color expert option; a color purpose option; a color room option; a color object option; and a color browse option; receiving, at the hardware device, data representing a user selection of: one of the one or more first selectable options, or one of the one or more second selectable options; enabling the display on a user hardware device of a hierarchical menu comprising selectable categories relating to the user selection; receiving, at the hardware device, data representing a user selection of a category from among the selectable categories; enabling the display on a user hardware device of one or more selectable material coating color options relating to the user selection of the category; receiving, at the hardware device, data representing a user selection of one of the one or more selectable material coating color options; enabling the display on a user hardware device of an image showing a sample environment coated in the selectable material coating color option selected by the user, the image being modifiable, such as to change a material coating color based on a subsequent user selection of another of the one or more selectable coating color options; and enabling the display on a user hardware device of a checkout link to the user that enables the user to purchase one or more material coatings corresponding to one or more of the one or more selectable coating color options. Embodiment is the method of embodiment 1, further comprising, after receiving a user selection of a color style option: enabling the display on a user hardware device of one or more selectable decorative themes; receiving, at the hardware device, data representing a user selection of one of the one or more selectable decorative themes; and enabling the display on a user hardware device of a plurality of selectable material coating color options, color palettes, and color ideas based on the selected decorative theme. Embodiment 3 is the method of embodiment 1, further comprising, after receiving a user selection of a color expert option: enabling the display on a user hardware device of one or more selectable expert names; receiving, at the hardware device, data representing a user selection of one of the one or more selectable expert names; and enabling the display on a user hardware device of a plurality of selectable material coating color options, color palettes, and color ideas based on at least one recommendation of an expert corresponding to the selected expert name. Embodiment 4 is the method of embodiment 1, further comprising, after receiving a user selection of a color purpose option: enabling the display on a user hardware device of one or more selectable decorating purposes; receiving, at the hardware device, data representing a user selection of one of the one or more selectable decorating purposes; and enabling the display on a user hardware device of a plurality of selectable material coating color options, color palettes, and color ideas based on the selected decorating purpose. Embodiment 5 is the method of embodiment 1, further comprising, after receiving a user selection of a color room option: enabling the display on a user hardware device of one or more selectable room categories; receiving, at the hardware device, data representing a user selection of one of the one or more selectable room categories; and enabling the display on a user hardware device of a plurality of room images corresponding to the selected room category. Embodiment 6 is method of embodiment 5, further comprising: enabling the display on a user hardware device of a selectable color menu comprising a plurality of color categories; receiving, at the hardware device, data representing a user selection of a color category from among the plurality of color categories comprising the selectable color menu; enabling the display on a user hardware device of a modified plurality of room images having a color scheme corresponding to the selected color category; receiving, at the hardware device, data representing a user selection of one of the one or more modified room images; and enabling the display on a user hardware device of a plurality of selectable material coating color options, color palettes, and color ideas based on the selected modified room image. Embodiment 7 is the method of embodiment 1, further comprising, after receiving a user selection of a color object option: enabling the display on a user hardware device of one or more selectable objects having preset color schemes; and receiving, at the hardware device, data representing a user selection of one of the one or more selectable objects, where the user selection comprises one or more of a color inquiry and a project inquiry. Embodiment 8 is the method of embodiment 7, further comprising, after receiving a user selection of a color inquiry, enabling the display on a user hardware device of a plurality of selectable material coating color options, color palettes, and color ideas based on the preset color scheme of the selected selectable object. Embodiment 9 is the method of embodiment 7, further comprising, after receiving a user selection of a project inquiry, enabling the display on a user hardware device of an interactive project interface comprising construction instructions for creating an object corresponding to the selected selectable object. Embodiment 10 is the method of embodiment 1, further comprising, after receiving a user selection of a color browse option: enabling the display on a user hardware device of one or more selectable dropdown menus corresponding to one or more project type, surface type, and coating product type; receiving, at the hardware device, data representing a user selection of one or more options from the one of the one or more selectable dropdown menus; and enabling the display on a user hardware device of one or more selectable color categories related to the selected one or more options. Embodiment 11 is the method of embodiment 1, further comprising, after receiving a user selection of a color browse option: enabling the display on a user hardware device of one or more selectable color categories; receiving, at the hardware device, data representing a user selection of one of the one or more selectable color categories; enabling the display on a user hardware device of one or more selectable color shades based on the selected selectable color category; enabling the display on a user hardware device of the image; and enabling the display on a user hardware device of a plurality of selectable material coating color options, color palettes, and color ideas based on the selected selectable color shade. Embodiment 12 is the method of embodiment 11, the plurality of selectable color options being arranged in a carousel format in an order of lighter to darker color shade, the selectable color options further comprising one or more scroll buttons. Embodiment 13 is the method of embodiment 12, where the image is modifiable to display a color corresponding to a user selection of one of the plurality of selectable color options. Embodiment 14 is the method of embodiment 1, further comprising: receiving, at the hardware device, data representing a user selection of a project type to be coated; enabling the display on a user hardware device of a list of material coating attributes corresponding to the selected project type; receiving, at the hardware device, data representing a user selection of one of one or more material coating attributes; and enabling the display on a user hardware device of a list of material coatings exhibiting the selected material coating attribute. Embodiment 15 is the method of embodiment 1, further comprising: enabling the display on a user hardware device of a list of transparencies and transparency attributes corresponding to the selected selectable color option; and receiving, at the hardware device, data representing a user selection of a transparency from among the list of transparencies, where the list of transparencies is arranged in an order of least transparent to most transparent. Embodiment 16 is the method of embodiment 1, further comprising: enabling the display on a user hardware device of a list of sheens and sheen attributes corresponding to the selected selectable color option; and receiving, at the hardware device, data representing a user selection of a sheen from among the list of sheens, where the list of sheens is arranged in an order of matte to shiny sheens. Embodiment 17 is the method of embodiment 1, further comprising: receiving, at the hardware device, data representing a user selection of the checkout link; receiving, at the hardware device, data representing a user selection of a desired unit amount to purchase; enabling the display on a user hardware device of one or more material coating brand options and corresponding pricing information; receiving, at the hardware device, data representing a user selection of one of the one or more material coating brand options; and enabling the display on a user hardware device of a shopping cart containing the desired unit amount of the selected material coating brand that enables the user to complete a purchase transaction. Embodiment 18 is a computing system for implementing an online coating material application, the computing system comprising: a memory device; and at least one processor configured to enable the display of a graphical user interface (GUI) comprising one or more graphical elements configured to implement, using the at least one processor, one or more software applications stored on one or more servers, the one or more software applications configured to: initiate a session of an online coating material application by receiving a user input on a user interface running or stored on a hardware device comprising at least one processor; enable the display on a user hardware device of one or more of a plurality of first selectable options comprising one or more of: an interior coating exploration option; an exterior coating exploration option; and a project exploration option; enable the display on a user hardware device of one or more of a plurality of second selectable options comprising one or more of: a color style option; a color expert option; a color purpose option; a color room option; a color object option; and a color browse option; receive, at the hardware device, data representing a user selection of: one of the one or more first selectable options, or one of the one or more second selectable options; enable the display on a user hardware device of a hierarchical menu comprising selectable categories relating to the user selection; receive, at the hardware device, data representing a user selection of a category from among the selectable categories; enable the display on a user hardware device of one or more selectable material coating color options relating to the user selection of the category; receive, at the hardware device, data representing a user selection of one of the one or more selectable material coating color options; enable the display on a user hardware device of an image showing a sample environment coated in the selectable material coating color option selected by the user, the image being modifiable, such as to change a material coating color based on a subsequent user selection of another of the one or more selectable coating color options; and enable the display on a user hardware device of a checkout link to the user that enables the user to purchase one or more material coatings corresponding to one or more of the one or more selectable coating color options. Embodiment 19 is the computer system of embodiment 18, the one or more software applications being further configured to, after receiving a user selection of a color style option: enable the display on a user hardware device of one or more selectable decorative themes; receive, at the hardware device, data representing a user selection of one of the one or more selectable decorative themes; and enable the display on a user hardware device of a plurality of selectable material coating color options, color palettes, and color ideas based on the selected decorative theme. Embodiment 20 is the computer system of embodiment 18, the one or more software applications being further configured to, after receiving a user selection of a color expert option: enable the display on a user hardware device of one or more selectable expert names; receive, at the hardware device, data representing a user selection of one of the one or more selectable expert names; and enable the display on a user hardware device of a plurality of selectable material coating color options, color palettes, and color ideas based on at least one recommendation of an expert corresponding to the selected expert name. Embodiment 21 is the computer system of embodiment 18, the one or more software applications being further configured to, after receiving a user selection of a color purpose option: enable the display on a user hardware device of one or more selectable decorating purposes; receive, at the hardware device, data representing a user selection of one of the one or more selectable decorating purposes; and enable the display on a user hardware device of a plurality of selectable material coating color options, color palettes, and color ideas based on the selected decorating purpose. Embodiment 22 is the computer system of embodiment 18, the one or more software applications being further configured to, after receiving a user selection of a color room option: enable the display on a user hardware device of one or more selectable room categories; receive, at the hardware device, data representing a user selection of one of the one or more selectable room categories; and enable the display on a user hardware device of a plurality of room images corresponding to the selected room category. Embodiment 23 is the computer system of embodiment 22, the one or more software applications being further configured to: enable the display on a user hardware device of a selectable color menu comprising a plurality of color categories; receive, at the hardware device, data representing a user selection of a color category from among the plurality of color categories comprising the selectable color menu; enable the display on a user hardware device of a modified plurality of room images having a color scheme corresponding to the selected color category; receive, at the hardware device, data representing a user selection of one of the one or more modified room images; and enable the display on a user hardware device of a plurality of selectable material coating color options, color palettes, and color ideas based on the selected modified room image. Embodiment 24 is the computer system of embodiment 18, the one or more software applications being further configured to, after receiving a user selection of a color object option: enable the display on a user hardware device of one or more selectable objects having preset color schemes; and receive, at the hardware device, data representing a user selection of one of the one or more selectable objects, where the user selection comprises one or more of a color inquiry and a project inquiry. Embodiment 25 is the computer system of embodiment 24, the one or more software applications being further configured to, after receiving a user selection of a color inquiry, enable the display on a user hardware device of a plurality of selectable material coating color options, color palettes, and color ideas based on the preset color scheme of the selected selectable object. Embodiment 26 is the computer system of embodiment 24, the one or more software applications being further configured to, after receiving a user selection of a project inquiry, enable the display on a user hardware device of an interactive project interface comprising construction instructions for creating an object corresponding to the selected selectable object. Embodiment 27 is the computer system of embodiment 18, the one or more software applications being further configured to, after receiving a user selection of a color browse option: enable the display on a user hardware device of one or more selectable dropdown menus corresponding to one or more project type, surface type, and coating product type; receive, at the hardware device, data representing a user selection of one or more options from the one of the one or more selectable dropdown menus; and enable the display on a user hardware device of one or more selectable color categories related to the selected one or more options. Embodiment 28 is the computer system of embodiment 18, the one or more software applications being further configured to, after receiving a user selection of a color browse option: enable the display on a user hardware device of one or more selectable color categories; receive, at the hardware device, data representing a user selection of one of the one or more selectable color categories; enable the display on a user hardware device of one or more selectable color shades based on the selected selectable color category; enable the display on a user hardware device of the image; and enable the display on a user hardware device of a plurality of selectable material coating color options, color palettes, and color ideas based on the selected selectable color shade. Embodiment 29 is the computer system of embodiment 28, the plurality of selectable color options being arranged in a carousel format in an order of lighter to darker color shade, the selectable color options further comprising one or more scroll buttons. Embodiment 30 is the computer system of embodiment 29, where the image is modifiable display on a user hardware device a color corresponding to a user selection of one of the plurality of selectable color options. Embodiment 31 is the computer system of embodiment 18, the one or more software applications being further configured to: receive, at the hardware device, data representing a user selection of a project type to be coated; enable the display on a user hardware device of a list of material coating attributes corresponding to the selected project type; receive, at the hardware device, data representing a user selection of one of one or more material coating attributes; and enable the display on a user hardware device of a list of material coatings exhibiting the selected material coating attribute. Embodiment 32 is the computer system of embodiment 18, the one or more software applications being further configured to: enable the display on a user hardware device of a list of transparencies and transparency attributes corresponding to the selected selectable color option; and receive, at the hardware device, data representing a user selection of a transparency from among the list of transparencies, where the list of transparencies is arranged in an order of least transparent to most transparent. Embodiment 33 is the computer system of embodiment 18, the one or more software applications being further configured to: enable the display on a user hardware device of a list of sheens and sheen attributes corresponding to the selected selectable color option; and receive, at the hardware device, data representing a user selection of a sheen from among the list of sheens, where the list of sheens is arranged in an order of matte to shiny sheens. Embodiment 34 is the computer system of embodiment 18, the one or more software applications being further configured to: receive, at the hardware device, data representing a user selection of the checkout link; receive, at the hardware device, data representing a user selection of a desired unit amount to purchase; enable the display on a user hardware device of one or more material coating brand options and corresponding pricing information; receive, at the hardware device, data representing a user selection of one of the one or more material coating brand options; and enable the display on a user hardware device of a shopping cart containing the desired unit amount of the selected material coating brand that enables the user to complete a purchase transaction. Embodiment 35 is a computer program product, comprising: a non-transitory computer-readable medium comprising code to perform at least (the following steps): initiating a session of an online coating material application by receiving a user input at a hardware device comprising at least one processor; enabling the display on a user hardware device of one or more of a plurality of first selectable options comprising one or more of: an interior coating exploration option; an exterior coating exploration option; and a project exploration option; enabling the display on a user hardware device of one or more of a plurality of second selectable options comprising one or more of: a color style option; a color expert option; a color purpose option; a color room option; a color object option; and a color browse option; receiving, at the hardware device, data representing a user selection of: one of the one or more first selectable options, or one of the one or more second selectable options; enabling the display on a user hardware device of a hierarchical menu comprising selectable categories relating to the user selection; receiving, at the hardware device, data representing a user selection of a category from among the selectable categories; enabling the display on a user hardware device of one or more selectable material coating color options relating to the user selection of the category; receiving, at the hardware device, data representing a user selection of one of the one or more selectable material coating color options; enabling the display on a user hardware device of an image showing a sample environment coated in the one or more selectable material coating color option selected by the user, the image being modifiable, such as to change a material coating color based on a subsequent user selection of another of the one or more selectable coating color options; and enabling the display on a user hardware device of a checkout link to the user that enables the user to purchase one or more material coatings corresponding to one or more of the one or more selectable coating color options. Embodiment 36 is a computing system for implementing an online coating material application, the computing system comprising: a memory device; and at least one processor configured to enable the display of a graphical user interface (GUI) comprising one or more graphical elements configured to implement, using the at least one processor, one or more software applications stored on one or more servers, the one or more software applications configured to: initiate a session of an online coating material application by receiving a user input on a user interface running or stored on a hardware device comprising at least one processor; enable the display on a user hardware device of one or more of a plurality of selectable options comprising one or more of: a live view option; a photo taking option; a photo loading option; a color matching option; a color searching option; and a tutorial option; receive, at the hardware device, data representing a user selection of one of the one or more selectable options; enable the display on a user hardware device of one or more coating material options based on the data representing a user selection of one of the one or more selectable options; enable the display on a user hardware device of a share option; enable the display on a user hardware device of a save option; enable the display on a user hardware device of a checkout option that enables a user to purchase one or more material coatings corresponding to the one or more coating material options. Embodiment 37 is the computer system of embodiment 36, the one or more software applications being further configured to, after receiving a user selection of the live view option, the photo taking option, or the photo loading option: enable the display on a user hardware device of an interactive image having one or more default colors; enable the display on a user hardware device of one or more toolbars, the one or more toolbars comprising one or more color icons and one or more color tool icons; receive, at the hardware device, a user selection of a portion of the interactive image; receive, at the hardware device, a selection of the one or more color icons; and enable the display on a user hardware device of a modified interactive image, where the portion of the interactive image is colored with the color corresponding to the selected one or more color icons. Embodiment 38 is the computer system of embodiment 37, the one or more software applications being further configured to: receive, at the hardware device, a user selection of one or more color tool icons, the color tool icons comprising one or more of: a color eraser option; a color sheen option; a lighting brightness option; a color details option; a color removal option; and a color comparison option; and enable the display on a user hardware device of a modified portion of the interactive image, where the color of the portion of the interactive image is modified according to the selected color tool icon. Embodiment 39 is the computer system of embodiment 38, where the color eraser option enables the erasure of a part or all of the color coloring the portion of the interactive image on a user hardware device. Embodiment 40 is the computer system of embodiment 38, where the color sheen option enables the modification of a color sheen of the color coloring the portion of the interactive image on a user hardware device. Embodiment 41 is the computer system of embodiment 38, where the lighting brightness option enables the modification of a lighting brightness of the portion of the interactive image on a user hardware device, the color coloring the portion of the interactive image being modified corresponding to the modification of the lighting brightness. Embodiment 42 is the computer system of embodiment 38, where the color details option enables the display of one or more of a color title and a color brand of the color coloring the portion of the interactive image on a user hardware device. Embodiment 43 is the computer system of embodiment 38, where the color removal option enables the removal of all of the color coloring the portion of the interactive image and the restoring the interactive image to the one or more default colors on a user hardware device. Embodiment 44 is the computer system of embodiment 38, where the color matching option enables the simultaneous display of the interactive image having one or more default colors adjacent to the modified interactive image, where a user may adjust a size of the interactive image and a size of the modified interactive image on a user hardware device. Embodiment 45 is the computer system of embodiment 36, the one or more software applications being further configured to, after receiving a user selection of the color matching option: enable the display on a user hardware device of an interactive image having one or more default colors; receive, at the hardware device, a user selection of a portion of the interactive image; enable the display on a user hardware device of one or more matching color icons, the color icons corresponding to colors that closely match the one or more default colors of the selected portion of the interactive image; receive, at the hardware device, a user selection of one of the matching color icons; and enable the display on a user hardware device of the portion of the interactive image colored in the color corresponding to the selected matching color icon. Embodiment 46 is the computer system of embodiment 36, the one or more software applications being further configured to, after receiving a user selection of the color searching option: enable the display on a user hardware device of one or more search options, the search options comprising a hierarchical menu search option allowing searching by color family; a text search option allowing searching by color name, color brand, color family, or material coating type; and a bar code scanning option allowing searching by scanning of coating product identification; and receive, at the hardware device, a user selection of one of the one or more search options.

The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, or a component of a system, that “comprises,” “has,” “includes” or “contains” one or more elements or features possesses those one or more elements or features, but is not limited to possessing only those elements or features. Likewise, a method that “comprises,” “has,” “includes” or “contains” one or more steps possesses those one or more steps, but is not limited to possessing only those one or more steps. Additionally, terms such as “first” and “second” are used only to differentiate structures or features, and not to limit the different structures or features to a particular order.

Any embodiment of any of the disclosed methods, systems, system components, or method steps can consist of or consist essentially of—rather than comprise/include/contain/have—any of the described elements, steps, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

The foregoing has outlined rather broadly certain features and technical advantages of embodiments of the present invention in order that the detailed description that follows may be better understood. Additional features and advantages will be described below. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

The following drawings illustrate by way of example and not limitation. For the sake of brevity and clarity, every feature of a given method or system is not always labeled in every figure related to that method or system. Identical reference numbers do not necessarily indicate an identical feature. Rather, the same reference number may be used to indicate a similar feature or a feature with similar functionality, as may non-identical reference numbers.

FIG. 1A depicts an embodiment of an online color selection method.

FIG. 1B depicts an exemplary network structure of an embodiment of an online color selection system.

FIG. 2 depicts a selectable option interface according to an embodiment of the online color selection system.

FIGS. 3A-3D depict selectable option interfaces for interior color products according to embodiments of the online color selection system.

FIGS. 4A-4D depict selectable category interfaces for interior color products according to embodiments of the online color selection system.

FIG. 5 depicts a selectable color option interface for interior color products displayable during use of an embodiment of the online inventory system.

FIGS. 6A-6B depict selectable modifiable image interfaces for interior color products according to embodiments of the online color selection system.

FIG. 7 depicts a project interface displayable during use of an embodiment of the online color selection system.

FIG. 8 depicts a selectable option interface for exterior color products according to an embodiment of the online color selection system.

FIGS. 9A-9B depict selectable category interfaces for exterior color products according to embodiments of the online color selection system.

FIGS. 10A-10B depict selectable modifiable image interfaces for exterior color products according to embodiments of the online color selection system.

FIGS. 11A-11G depict selectable product option interfaces according to embodiments of the online color selection system.

FIG. 12 depicts additional selectable options according to an embodiment of the online color selection system.

FIG. 13 depicts an online community interface according to an embodiment of the online color selection system.

FIGS. 14A-14D depict a mobile application interface according to embodiments of the online color selection system.

### DETAILED DESCRIPTION OF ILLUSTRATIVE EMBODIMENTS

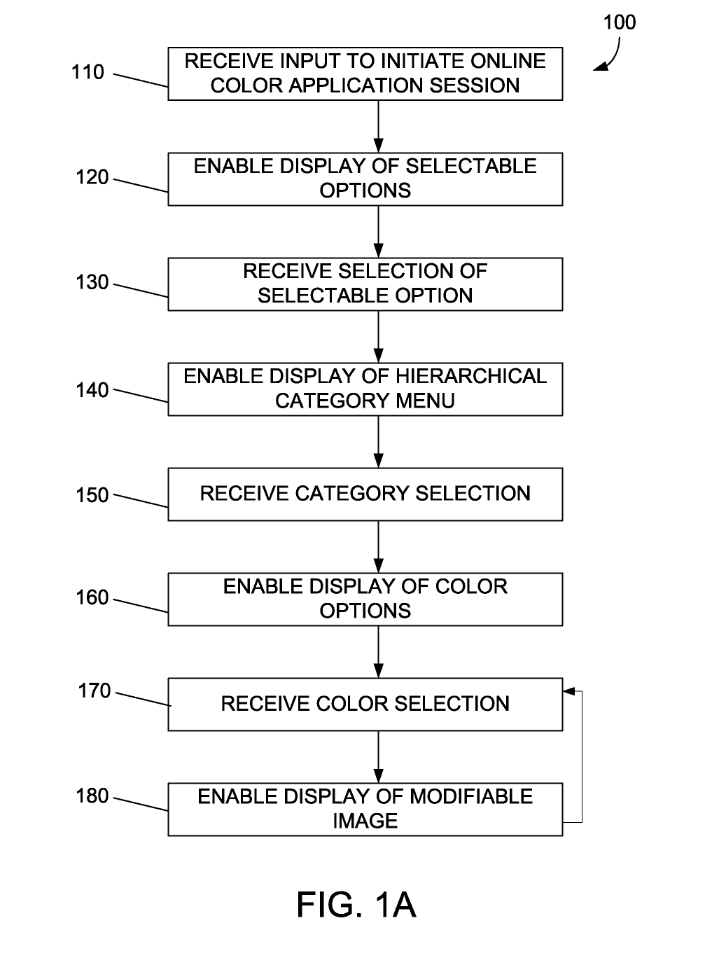

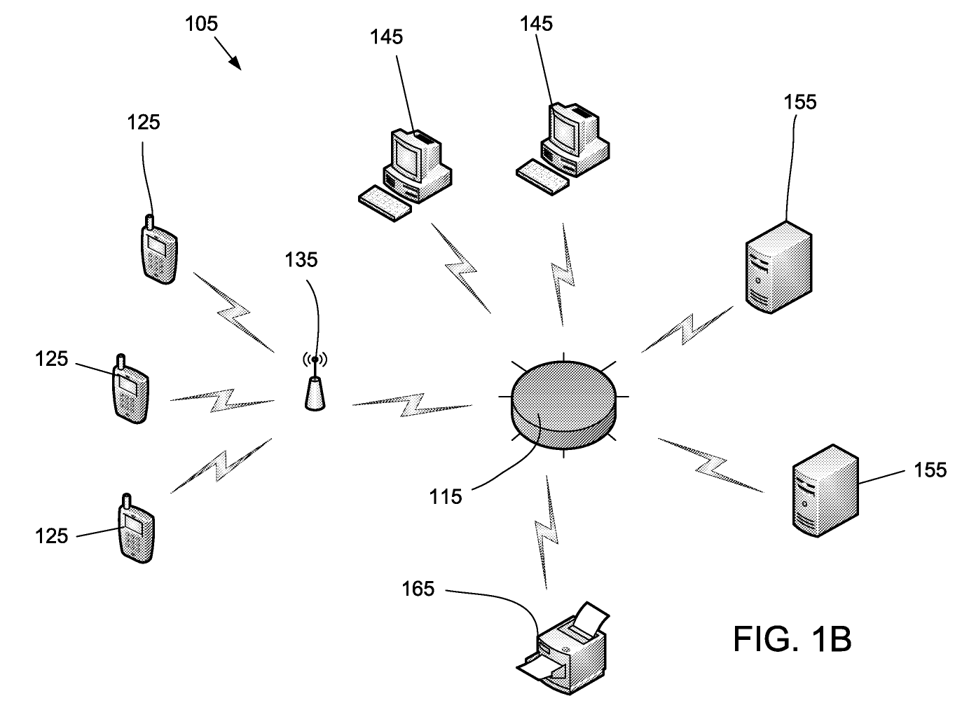

Referring now to the drawings, FIG. 1A illustrates an online color selection method 100 according to an embodiment of the disclosure. In the embodiment shown, method 100 may begin at step 110 by receiving a user input to initiate a color center session. In some embodiments, the system may initiate a color center session when a user accesses a hardware device connected to a network. The hardware device may be a personal computer located at a user's home. The hardware device may also be a mobile device such as a smartphone or a tablet computer. The hardware device may be configured to access one or more software applications that perform online color center functionalities. In some embodiments, the mobile device may have capability to download a mobile application tailored specifically to the mobile device. The system may initialize the color center session when a user opens a color center webpage using a web browser or opens a color center mobile application on the mobile device. Additional steps of method 100 are discussed below, after the following discussion of a suitable network environment for facilitating the performance of method 100.

FIG. 1B illustrates one embodiment of a network system 105 by which a user may access the color center system. In some embodiments, system 105 comprises a network hub 115, one or more mobile devices 125, one or more wireless hubs 135, one or more computing devices or registers 145 (e.g., personal computers), one or more servers 155, and one or more output devices 165. System 105 may comprise more or less mobile devices, wireless hubs, computing devices, output devices, and servers than shown in FIG. 1B. Computing devices 145, servers 155, and output device 165 may be connected to network hub 115 via wired or wireless protocols.

Servers 155 may store one or more software applications configured to facilitate performance of method 100. Broadly, the one or more software applications may assist a user in choosing a particular color of paint, stain, or varnish for one or more of a variety of projects, and perform functions such as displaying images of a variety of sample environments having different paint colors and lighting levels.

Mobile devices 125, computing devices 145, and output device 165 may access the one or more software applications stored on servers 155 via network hub 115. In some embodiments, mobile devices 125 and computing devices 145 store one or more software applications configured to facilitate performance of method 100, and may do so via storage on a respective local memory device. In still other embodiments, some (or aspects) of the one or more software applications configured to facilitate performance of method 100 may be stored on one or more servers 155 and some (or aspects) may be stored locally on a mobile device 125 or computing device 145.

In the performance of method 100, the user may access an interface on a mobile device and/or computing device (examples of a user hardware device) to trigger the performance of functionalities of the one or more software applications. In some embodiments, each of mobile devices 125, computing devices 145, and servers 155 may comprise one or more processors. In some embodiments, mobile devices 125, computing devices 145, and servers 155 may comprise a distributed computing system. In these embodiments, one processor within a mobile device 125 or a computing device 145 may perform a specific function of a software application while another processor may perform another specific function of the software application. For example, when using a mobile application stored on mobile device 125, one processor may receive and process a live image feed from a camera of the mobile device 125 while another processor may implement an augmented reality interface usable in conjunction with the live image feed. Similarly, objects used by the one or more software applications may be stored in different servers 155. For example, a paint color database may be stored in one server 155, while a default image database may be stored in another server 155. The one or more software applications may retrieve and use objects stored on multiple servers 155 to integrate them into a single graphical user interface (GUI) accessible by the user on mobile devices 125 or computing devices 145.

Returning to method 100, in the embodiment shown in FIG. 1A, the system may continue method 100 at step 120 by enabling the display of a plurality of selectable options to the user. In some embodiments, the system may enable the display by causing one or more processors configured for display functionality to perform actions that implement the display functionality. In some embodiments, the one or more processors may execute code or initiate one or more software applications that implement the display functionality. In some embodiments, the actions performed by the one or more processors may cause the plurality of selectable options to be displayed to the user via a mobile device and/or computing device. In some embodiments, some selectable options may be designed to help the user find colors for a particular style or purpose the user has in mind. Other selectable options may be designed to help the user think of new decorating ideas or come up with new projects. Other selectable options may allow a user to browse a catalog of colors for a specific desired color. These options may be displayed in one or more hierarchical menus that may contain one or more icons (any of which may be characterized as or take the form of a link) that may be selected by the user. The icons may represent the different selectable options available to the user. In the embodiment shown, the system may continue method 100 at step 130 by receiving a user selection from the hierarchical menu. The user may also make a selection by selecting an icon from the hierarchical menu. The user may select information from the hierarchical menu via a keyboard, mouse, touchscreen or touchpad, or in any other suitable manner.

In the embodiment shown, the system at step 140 may enable the display of a hierarchical category menu at the mobile device and/or computing device based on the user selection made from the plurality of selectable options. The hierarchical category menu may also contain one or more icons for selection by the user. The icons may represent different categories relevant to the option selected by the user. For example, if a user wants to find paint colors suitable for a particular interior decorating style, the hierarchical category menu may display different decorating style options the user may select. In the embodiment shown, the system may continue method 100 at step 150 by receiving a user selection from the hierarchical category menu. The user may make a selection by selecting an icon from the hierarchical category menu.

In the embodiment shown, the system at step 160 may enable the display of a plurality of color options. The color options may represent a variety of colors relevant to the category option selected by the user. In some embodiments, the color options may be displayed in close vicinity to each other to allow the user to compare and contrast the color options. These color options may be displayed as one or more colored icons for selection by the user. In the embodiment shown, the system may continue method 100 at step 170 by receiving a user selection from the plurality of color options. The user may make a selection by selecting a color icon.

In the embodiment shown, the system at step 180 may enable the display of a modifiable image of a particular environment or object painted in the color option corresponding to the user selection received by the system. The system may modify the image in multiple ways. For example, the system may receive a user selection of a different type of environment or object to be shown in the image to enable the display of how the color option would look in a variety of settings. In the embodiment shown, the system may repeat step 170 as many times as necessary to receive additional user selections from the plurality of color options. Upon receipt of a new color selection, the system may repeat step 180 to enable the display of a modified image painted in the new color option corresponding to the additional user selection. The system may modify the color of the image as many times as desired by receiving user selections of different color options. This functionality may assist the user to visualize how the selected paint color may look in the user's house or other setting to be painted. After the system has received user selections of all desired options, the system may enable the display of purchase options to the user. In some embodiments, these purchase options may include brand choice, sheen choice, and unit amount choice.

The method of FIG. 1A may also be applied to material coatings other than paint. For example, rather than receiving one or more paint color options, the system may enable the display of one or more varnish, stain, or lacquer options to the user. These options may include color, type, sheen, durability, and/or other coating characteristics. In some embodiments, the environments the system may enable to be portrayed in the modifiable image of step 180 may be tailored to different coating types. For example, rather than displaying a living room wall coated with a particular paint color, the image may display a backyard deck coated with a particular type of waterproof sealant. The system may then further enable the modification of the image of the backyard deck to display different colors of stain for the wood and other coating options based on receiving a user selection of different coating options.

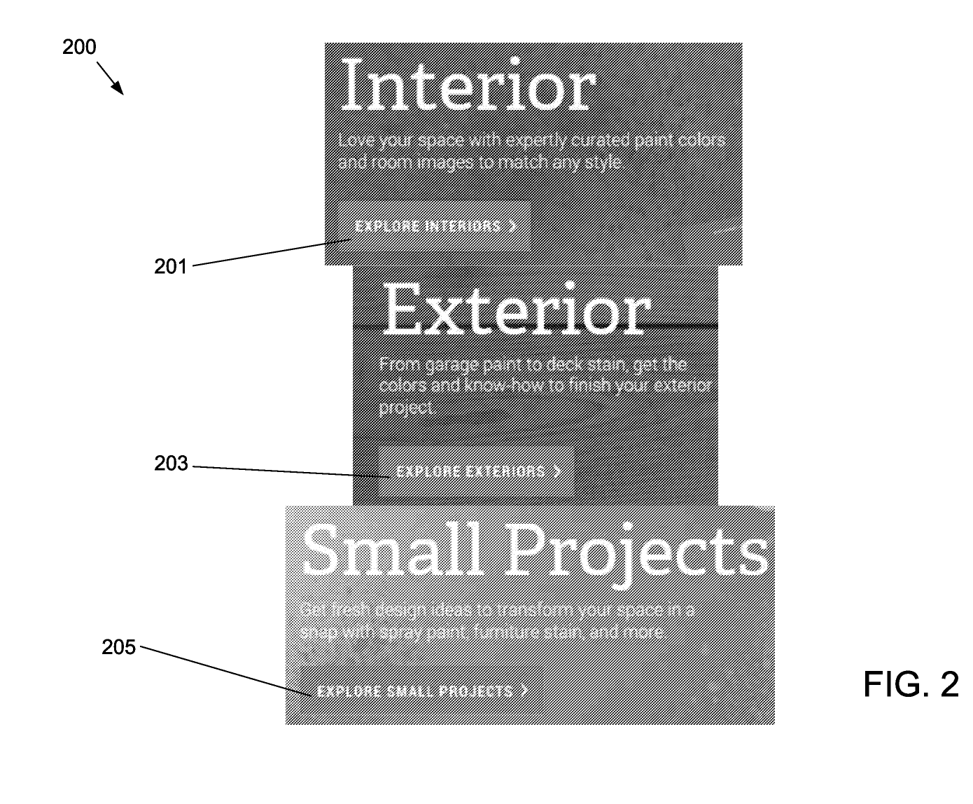

FIGS. 2A-13 show examples of a graphical user interface (GUI) that may be displayed on a mobile device and/or computing device. The GUI may be used by a user to implement one or more software applications to perform one or more embodiments of method 100 (see FIG. 1A). The GUI may be implemented using a suitable operating platform, such as Windows, Android, and Apple iOS.

FIG. 2 shows embodiments of exemplary selectable option icons 200 that may be presented to a user. In the embodiment shown in FIG. 2, selectable option icons 200 may include interior coating option icon 201, exterior coating option icon 203, and explore projects option icon 205. In some embodiments, the functionality triggered by a user selection of interior coating option icon 201 may allow the user to access additional user selectable icons to find recommendations for various types of interior coatings (e.g., indoor paint, stain or varnish for wood floors, etc.). The functionality triggered by a user selection of exterior coating option icon 203 may allow the user to access additional user selectable icons to find recommendations for various types of exterior coatings (e.g., outdoor paint, stain or waterproof sealant for wood or hard materials, etc.). The functionality triggered by a user selection of explore projects option icon 205 may allow a user to browse various home projects for inspiration, access coating recommendations, and explore coating options for different project types.

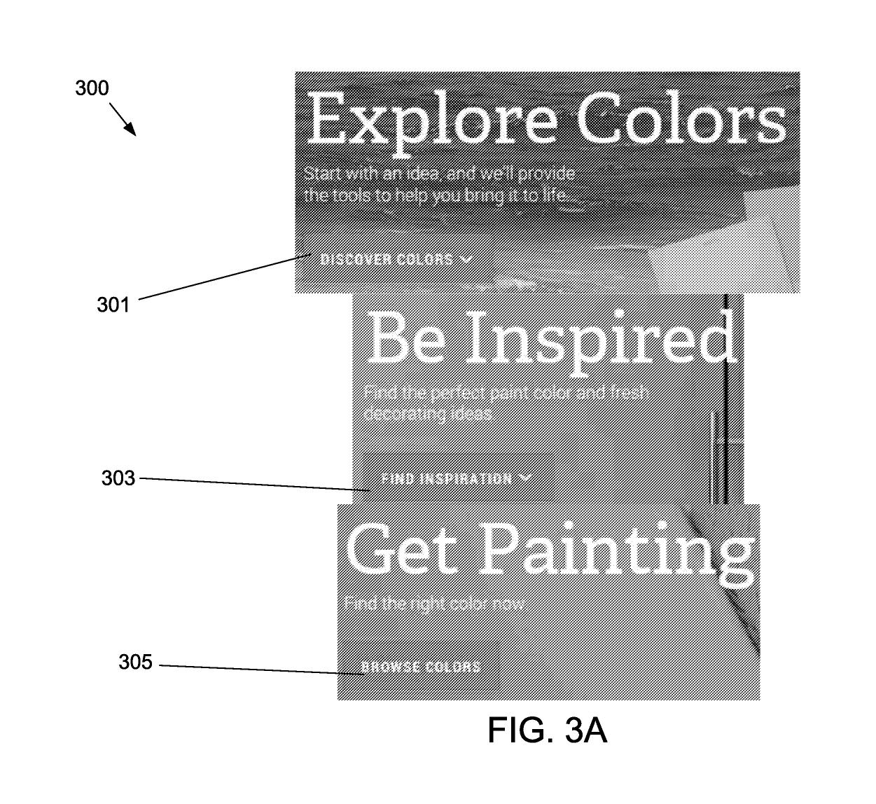

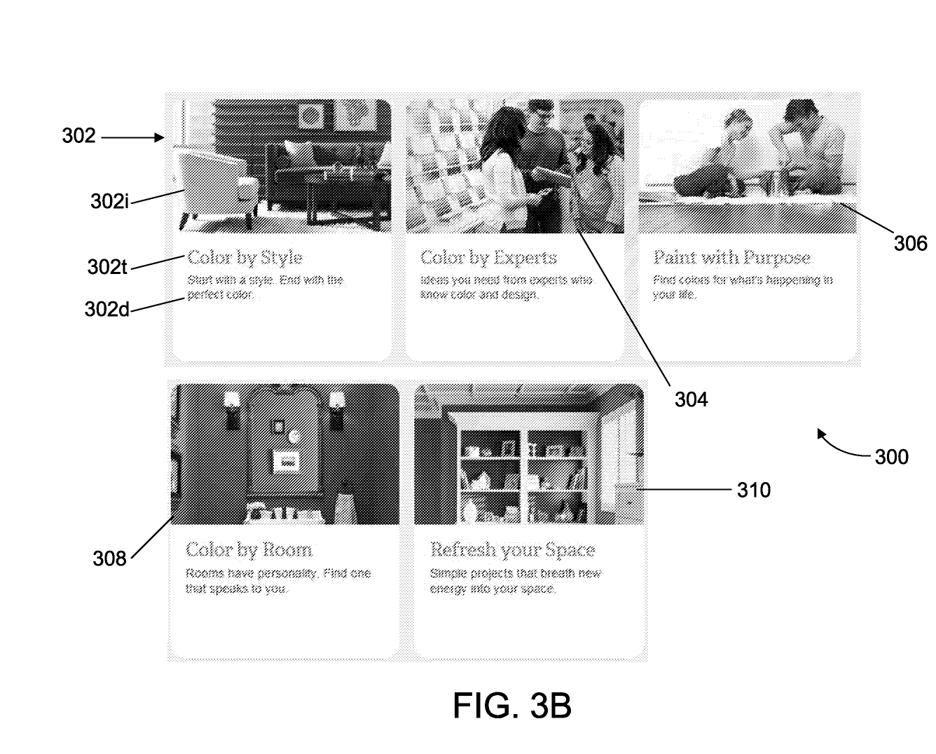

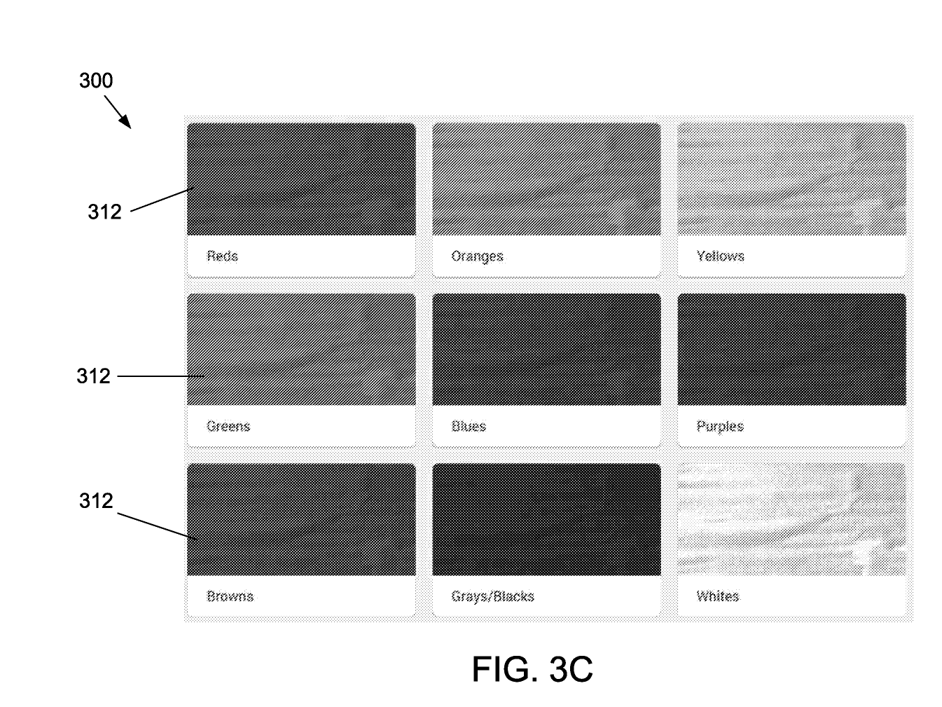

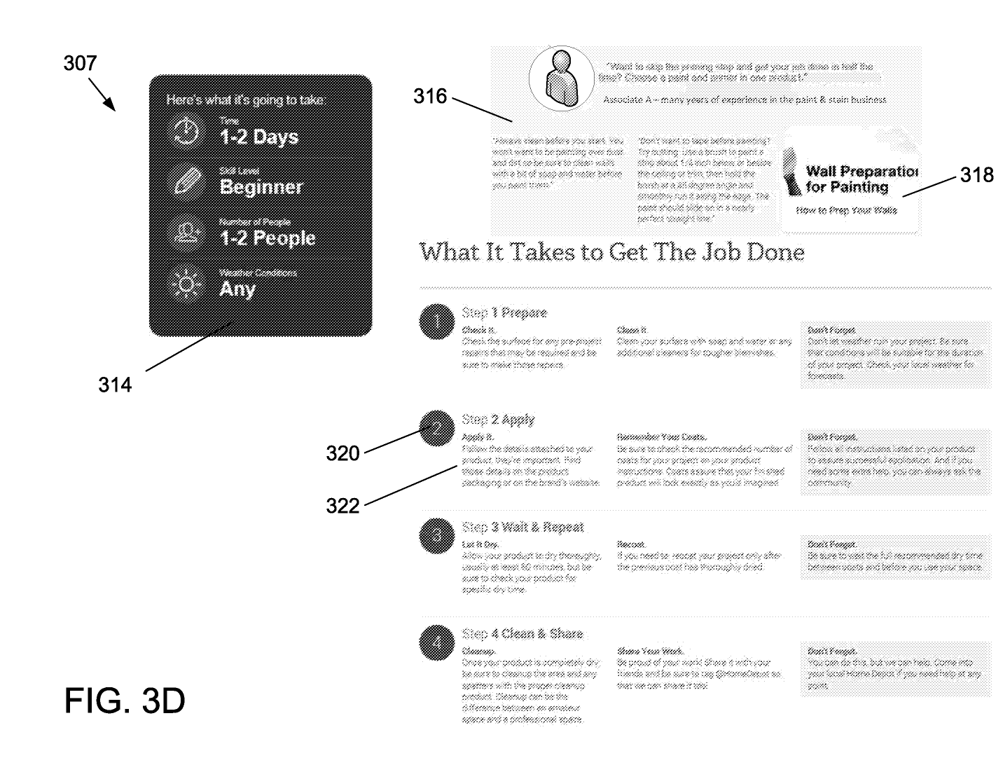

FIGS. 3A-3D show embodiments of exemplary selectable option icons 300 that may be presented to a user, as discussed above in step 120 of method 100 (see FIG. 1A). In some embodiments, selectable option icons 300 may be presented to the user upon selection of interior coating option icon 201 shown in FIG. 2. In the embodiment shown in FIG. 3A, selectable option icons 300 may include color recommendation option icon 301, color scheme inspiration option icon 303, and color browse option icon 305. In some embodiments, the functionality triggered by a user selection of color recommendation option icon 301 may allow the user to navigate hierarchical menu levels to find recommendations for colors matching various categories. The functionality triggered by a user selection of color scheme inspiration option icon 303 may allow the user to navigate hierarchical menu levels to find decoration ideas by browsing through various household objects and/or rooms decorated in different color schemes. The functionality triggered by a user selection of color browse option icon 305 may allow a user who already has a specific color in mind to browse through hierarchical menu levels to find the desired color. In the embodiment shown, icons 301, 303, 305 may comprise dropdown menus that expand and contract to display a next-level hierarchy of options, as shown in FIG. 3B. The selectable option icons 300 may also be tailored to other types of material coatings.

In the embodiment shown in FIG. 3B, selectable option icons 300 may include icons for options to search for a color based on a particular decorative style 302, recommendations by respected expert decorators 304, life events or particular decorating purposes 306, a particular room type 308, or recommendations of particular objects or projects for decorating 310. Each icon (e.g., 302) may include text (e.g., 302t) listing an option type along with a short description (e.g., 302d) of that option type. Each icon may also include an image (e.g., 302i) that may depict an example scene associated with the option type. The functionality triggered by a user selection of a particular option icon may drill down to a list of corresponding categories. The functionality triggered by selecting a particular category may drill down to a list of corresponding color options. Additional levels of hierarchical menu levels may also be implemented.

The functionality triggered by a user selection of decorative style option icon 302 may allow the user to find a paint color that matches a decorative style, motif, or theme of a setting, room, or environment that the user wants to paint. This option may be particularly useful when the user does not have any specific paint colors in mind but wants to explore colors that fit within a particular style.

The functionality triggered by a user selection of expert recommendation option icon 304 may allow the user to access paint color recommendations from a plurality of different experts to assist in the user's paint color decision making. In some embodiments, the experts may specialize in different fields. For example, one expert may specialize in paint colors and sheens, another expert may specialize in kitchen decoration, while another expert may specialize in overall modern interior design. The user may access these different types of recommendations to gain paint color ideas and help narrow down paint color choices.

The functionality triggered by a user selection of purpose option icon 306 may allow the user to find a paint color that matches a genre, motif or theme corresponding to a purpose or reason the user has for decorating a setting, room, or environment. For example, one user may want to repaint a guest bedroom to turn it into a nursery for a new baby or may want to create better decorative color flow between a kitchen and a living room. The functionality triggered by a user selection of purpose option icon 306 may present paint colors that are recommended for these particular purposes.

The functionality triggered by a user selection of room type option icon 308 may allow the user to find a paint color that is recommended for certain room types. For example, the user may want to paint his living room but may not have any particular color ideas. The functionality triggered by a user selection of room type option icon 308 may provide color recommendations that are tailored to living areas.

The functionality triggered by a user selection of object or project option icon 310 may present a multitude of household objects, each having a different color scheme. This presentation may allow the user to explore new ideas or inspirations for projects for creating new decorative objects or unique paint color schemes associated with those objects.

In systems tailored to other types of material coatings, the functionality triggered selectable option icons 300 may be modified accordingly. For example, if the user is looking for a lacquer for wood flooring, the option icons may comprise options for flooring style, lacquer expert recommendations, purposes for lacquering, lacquers tailored for different rooms, and various lacquering projects. These options may be similar to the paint options displayed in the embodiment shown in FIG. 3B.

In the embodiment shown in FIG. 3C, selectable option icons 300 may include color search option icons 312 to search for a color based on color type. The functionality triggered by this color browsing option may be especially useful when the user knows the general paint color they want but want to explore additional shades, feels, and nuances within that general color. It is noted that the user may reach a particular color by using any of these options. Option icons 300 are provided to allow the user to select one of many convenient options to arrive at a desired paint color. In some embodiments, the user may search for a particular color by inputting one or more of a color name, color coding number, or scannable barcode. In some embodiments, colors or shades of other types of material coatings may be displayed.

In the embodiment shown in FIG. 3D, instructional information 307 may be displayed to the user at various steps in the implementation of method 100. In the embodiment shown, instructional information 307 may be displayed in conjunction with color search option icons 312. Project summary 314 may be displayed to inform the user—via text, graphics, or a combination of both—about certain project attributes, such as one or more of an estimated time to complete the project, an estimated skill level necessary to complete the project, an estimated number of people necessary to complete the project, and weather conditions recommended to complete the project. In the embodiment shown, project summary 314 reflects project attributes of painting interior surfaces. The attributes listed in project summary 314 may be modified to reflect the attributes of different types of projects.

The user may also access expert recommendations 316 that are relevant to the type of project and/or coating being explored. Expert recommendations 316 may offer one or more tips from one or more various experts for completing the project. In some embodiments, expert recommendations 316 may comprise one or more video links 318 for accessing videos of demonstrations and/or tutorials created by an expert or experts for completing the project. The user may also access project instructions having one or more instructional steps 320 displayed with corresponding instructions 322 for completing the project. In some embodiments, instructional information 307 may be designed to be exhaustive. For example, a user that consults project summary 314, reads expert recommendations 316, accesses video link 318, and follows instructional steps 320 would theoretically be equipped with enough information to complete projects within the user's skill level. In some embodiments, instructional information 307 may be designed to be complementary to merely impart tips to users to complete projects using optimal methods.

There are several ways, consistent with the disclosed systems and methods, in which a user may reach a given option. The following examples illustrate some of those ways and the functionality by which they can be achieved. For example, a customer may be expecting a new baby boy and may want to search for possible colors for painting a nursery. The customer may use one or more selectable option icons, as shown in FIGS. 3A-3C to explore the different options discussed above. In one example, the customer may know that they want to paint the nursery a type of blue but may be unsure of the shade or hue. By using color search option icons 312 (see FIG. 3C), the customer may browse various types of blue to assist in making a decision. For purposes of the example, the customer may decide on a royal blue paint color.

In other examples, the customer may not have a particular color in mind but may know that he wants a modern interior style for the nursery. In one case, the customer may select decorative style option icon 302 (see FIG. 3B) to explore a variety of colors that fit a Modern style. The royal blue paint color may be presented as a possible Modern color option. Alternatively, the customer may select expert recommendation option icon 304 (see FIG. 3B) to view color recommendations from an expert in nursery or bedroom decoration. The expert may recommend the royal blue paint color as a popular option for a male child nursery. As another option, the customer may select purpose option icon 306 (see FIG. 3B) to view color options tailored to people expecting new children. The royal blue paint color may be presented as a color option tailored to this purpose.

The customer may also select room type option icon 308 (see FIG. 3B) to access color options tailored to a baby nursery. The royal blue paint color may be presented as a possible color option for a baby nursery. As another option, the customer may select object or project option icon 310 (see FIG. 3B) to view various home object and project ideas, some of which may be applicable to a nursery or expecting a new child. For example, a project for building a baby changing table may display royal blue as an attractive option for an object in a male child nursery. As can be seen from the above examples, the customer may arrive at the royal blue paint color in a plurality of ways, each avenue providing assistance based on the unique needs of the customer.

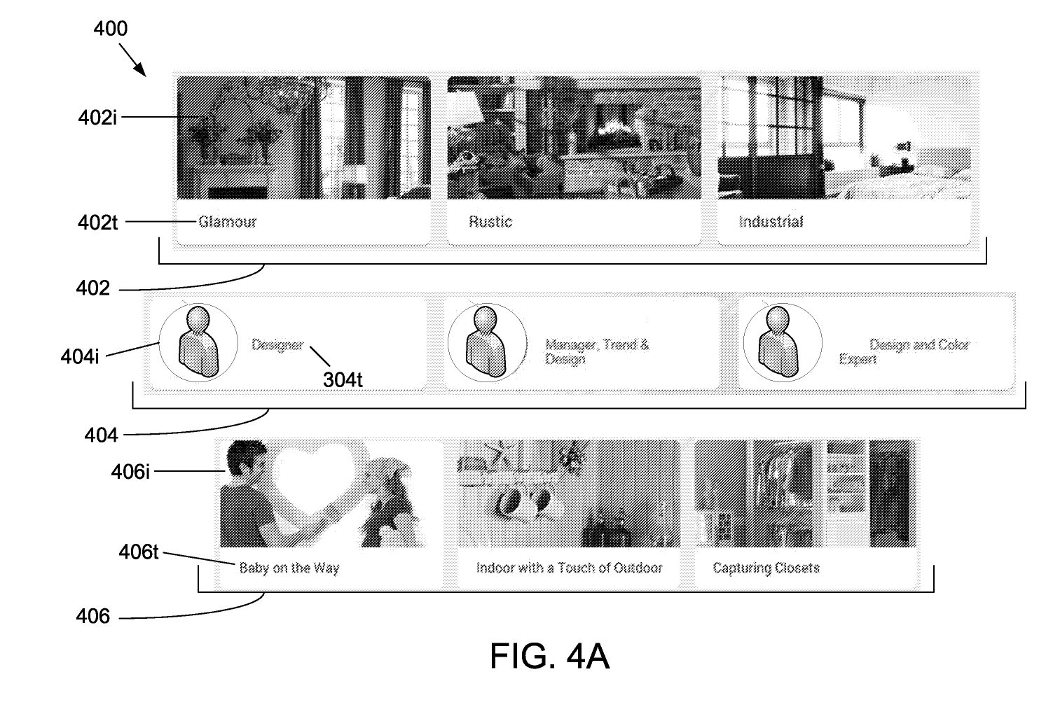

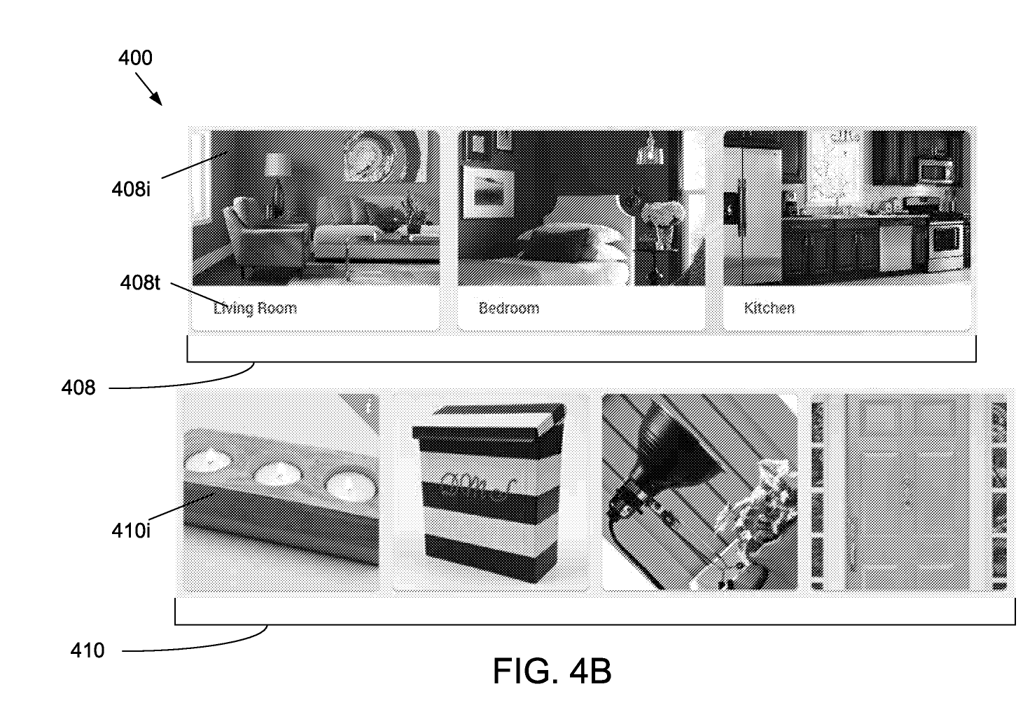

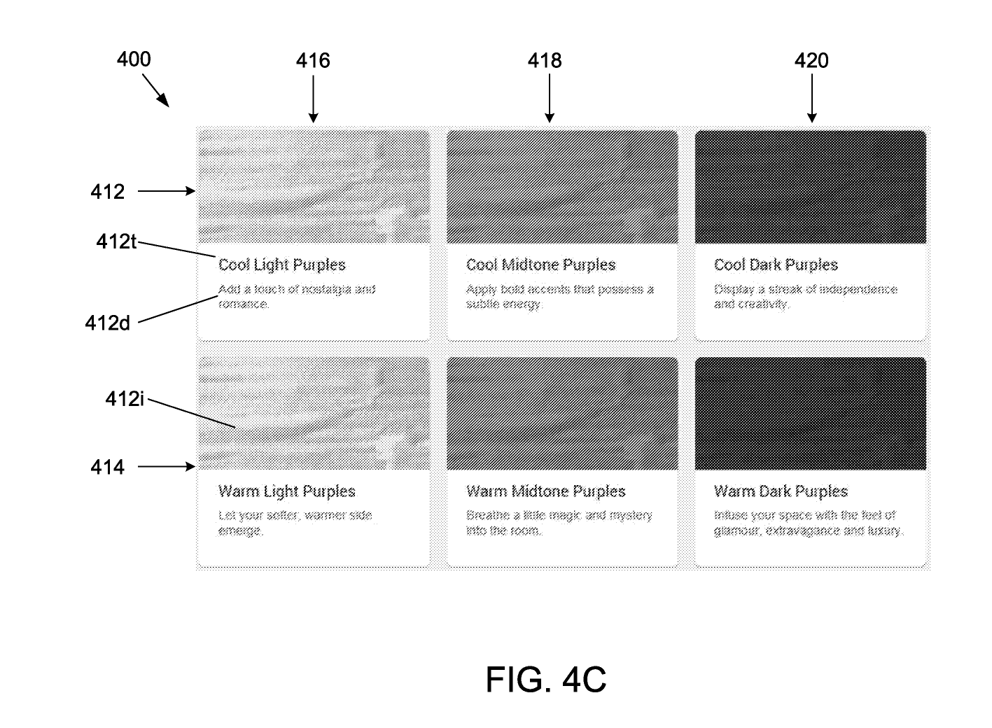

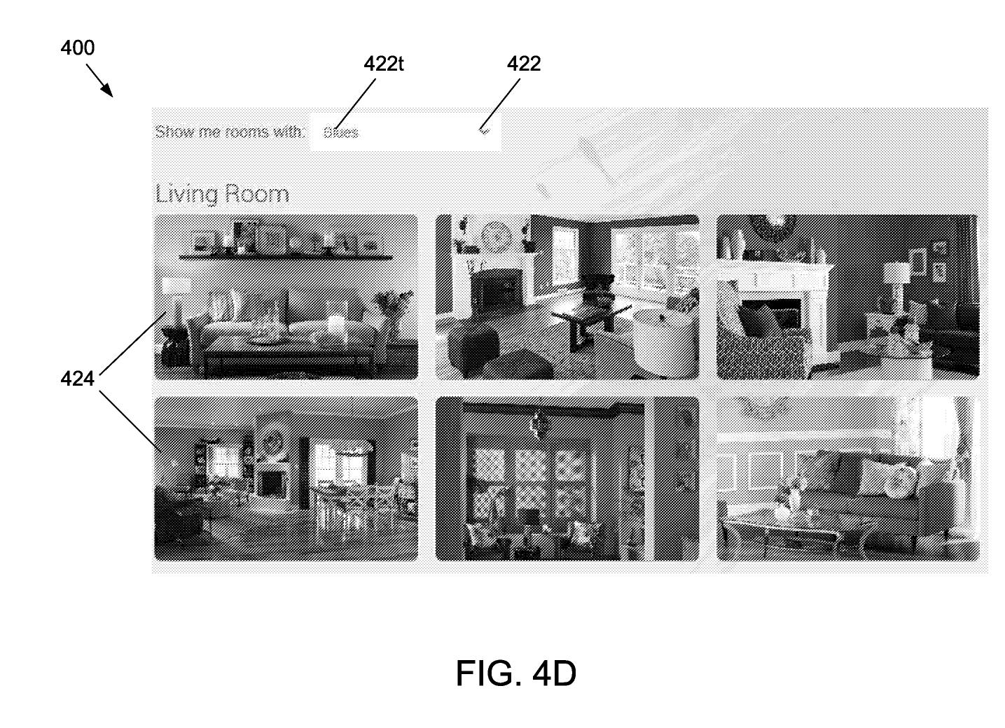

FIGS. 4A-4D show embodiments of exemplary selectable category icons 400 presented to a user upon selecting one of the option icons 300, as discussed above in step 140 of method 100 (see FIG. 1A). In the embodiment shown in FIG. 4A, selectable category icons 400 may include decorative style categories 402, expert decorator categories 404, life event or decorating purpose categories 406. The embodiment shown in FIG. 4A may be displayed when the user selects one of the option icons 302, 304, 306 shown in FIG. 3B. Decorative style categories icons 402 may contain text 402t listing an interior style (e.g., “Glamour,” “Rustic,” “Industrial”) and an image 402i displaying a room decorated in that style. For example, the user may desire to browse colors associated with a rustic interior style and may select the “Rustic” icon from the list of decorative style categories icons 402. Other style categories may include, without limitation, a modern living style, a country cottage style, a coastal/beach house style, an updated classic style, a traditional style, an arts and crafts/bungalow style, a glamour style, and an industrial style. Expert decorator categories icons 404 may contain text 404t listing an expert's name and area of expertise as well an image 404i representing the expert. For example, the user may desire to get recommendations from a paint expert and may select the “Designer C” icon to view recommendations tailored to a particular paint brand. Life event or purpose categories icons 406 may contain text 406t listing a life event or decorating purpose and an image 406i displaying a scene corresponding to the life event or purpose. For example, the user may desire to see paint colors tailored to the purpose of making an indoor space look more like an outside space and may select the appropriate corresponding purpose icon 406. Other purpose categories may include, without limitation, seasons, a new home office, a first apartment, a come together kitchen, a baby on the way, a guest room, a new home, a social space, a closet, a decorative makeover, and improving home color flow.

In the embodiment shown in FIG. 4B, selectable category icons 400 may include room type categories 408 and object or project categories 410. The embodiment shown in FIG. 4B may be displayed when the user selects one of the options 308, 310 shown in FIG. 3B. Room type categories 308 may contain text 408t listing a room type and an image 408i displaying a room corresponding to that type. For example, the user may desire to browse colors tailored to living rooms and may select the “Living Room” icon from the list of decorative style categories 408 Other room types may include, without limitation, a bedroom, a kitchen, a bathroom, a hallway/foyer, a dining room, a nursery, a kids room, and other rooms. Object or project categories 410 may contain an image 410i corresponding to a home project idea or a common home object painted in a unique color scheme. For example, the user may desire to find the paint colors of a front door and window trim or learn how to make the candle votive portrayed in the images 410i of the object category icons 410. Alternatively, after viewing an image 410i of a blue chandelier, the user may be inspired to paint a room in the same shade of blue.

In the embodiment shown in FIG. 4C, selectable category icons 400 may include cool color shade category icons 412, warm color shade category icons 414, light color shade category icons 416, midtone color shade category icons 418, and dark color shade category icons 420. The embodiment shown in FIG. 4C may be displayed when the user selects one of the option icons 312 shown in FIG. 3C. The category icons 400 may be arranged in a grid layout to display category icons 400 in an optimal and user-friendly manner. In the embodiment shown, category icons 400 are arranged into rows of cool color shade categories icons 412 and warm color shade categories icons 414. In the embodiment shown, category icons 400 are also arranged into columns of light color shade categories icons 416, midtone color shade categories icons 418, and dark color shade categories icons 420. Category icons 400 may contain text 412t listing a color shade category type, text 412d listing a short category description, and an image 412i portraying a sample shade of that color shade category. In some embodiments, option icons tailored to other material coatings may be displayed, such a varnish or stain color tones.

In the embodiment shown in FIG. 4D, selectable category icons 400 may include color type dropdown menu 422 and room sample images 424. The embodiment shown in FIG. 4D may be displayed when the user selects one of the room type categories icons 408 shown in FIG. 4B. If the user selects color type dropdown menu 422, the user may be presented with text 422t listing a variety of color types. The user may select a color type from color type dropdown menu 422 to modify the color schemes shown in room sample images 424 to reflect the color type selected by the user. For example, in the embodiment shown, the color type “Blues” has been selected from the color type dropdown menu 422. Room sample images 424 portray a plurality of sample rooms of the type corresponding to a room type category 408 selected by the user. In the embodiment shown, room sample images 424 portray sample rooms painted in a variety of blue shades. The variety of blue shades may show a mix of light, midtone, dark, cool, and warm color shades. If the user selects a different color type from color type dropdown menu 422, room sample images 424 may be modified accordingly to portray different color shades of the selected color type.

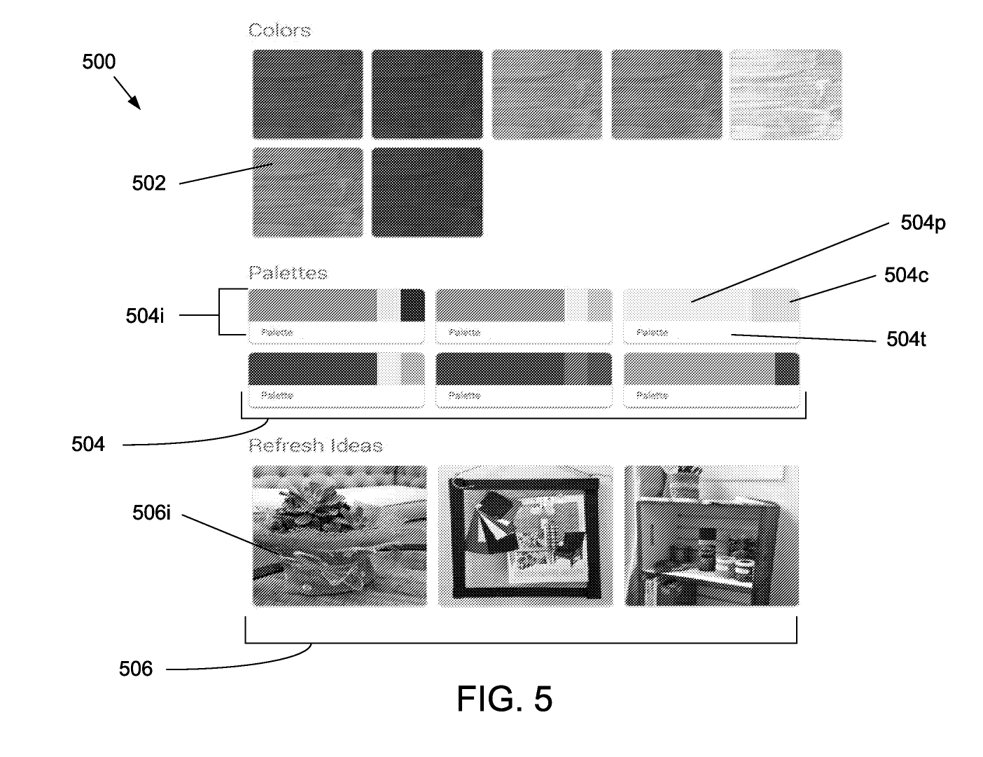

FIG. 5 shows embodiments of exemplary selectable color option icons 500 presented to a user upon selecting one of the category icons 400 (see FIGS. 4A-4D), as discussed above in step 160 of method 100 (see FIG. 1A). In the embodiment shown in FIG. 5, selectable color icons 500 may include single color icons 502, color palette icons 504, and refresh idea icons 506. The embodiment shown in FIG. 5 may be displayed when the user selects one of the category icons 402, 404, 406 shown in FIG. 4A, category icons 408, 410 shown in FIG. 4B, or room sample images 424 shown in FIG. 4D. Single color icons 502 and color palette icons 504 may display a plurality of colors and color palettes, respectively, related to the category icon 400 selected by the user. In the embodiment shown, a color palette icon 404 may display an image 504i of a group of suggested colors with a text description 504t of an entity that compiled the palette. In the embodiment shown, the format of a color palette icon 404 includes a main color 504p related to the user category selection and one or more accessory colors 504c for that main color. This may assist the user to find pre-compiled color schemes that are aesthetically pleasing. For example, if the user selected the rustic icon from the list of decorative style categories 402, single color icons 502 may display a plurality of colors often used or recommended when decorating in a rustic style. Additionally, color palette icons 504 may display color palettes that meld together to create an overall rustic color scheme. Refresh idea icons 506 may be similar to object or project categories 410 shown in FIG. 4B in that they contain an image 506i corresponding to a home project idea or a common home object painted in a unique color scheme. In the embodiment shown in FIG. 5, refresh idea icons 506 are tailored to the category icon 400 selected by the user. Continuing the examples above, if the user selects a rustic style, refresh idea icons 506 may display room types or household objects painted in colors or color schemes in the rustic style.

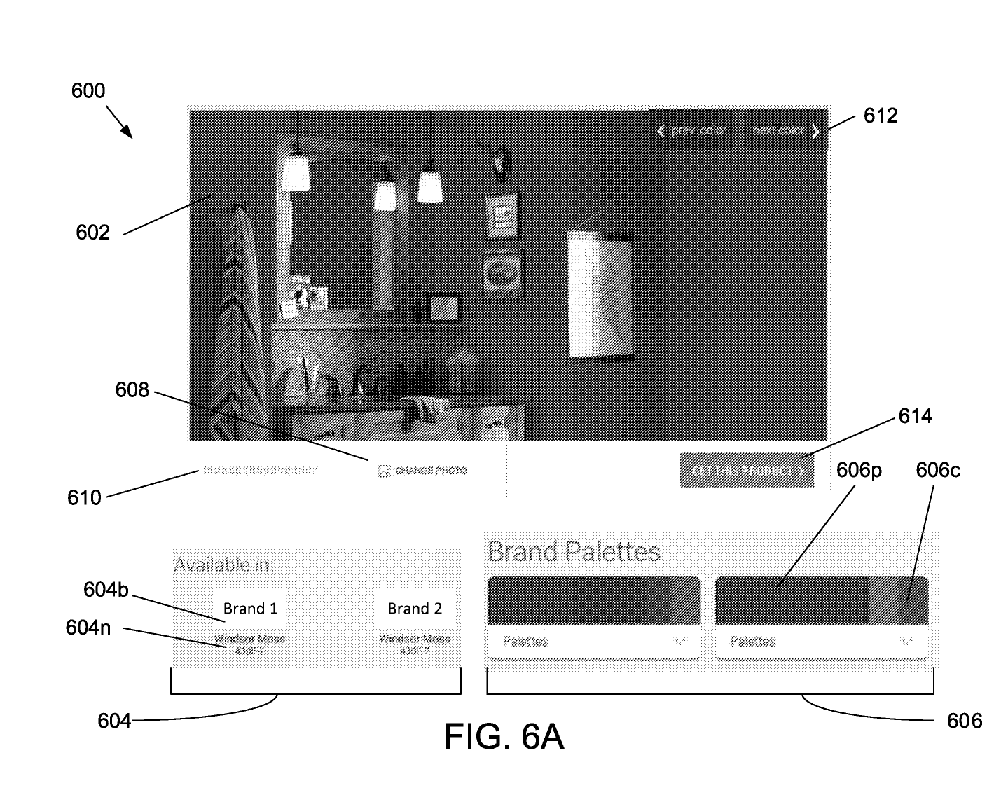

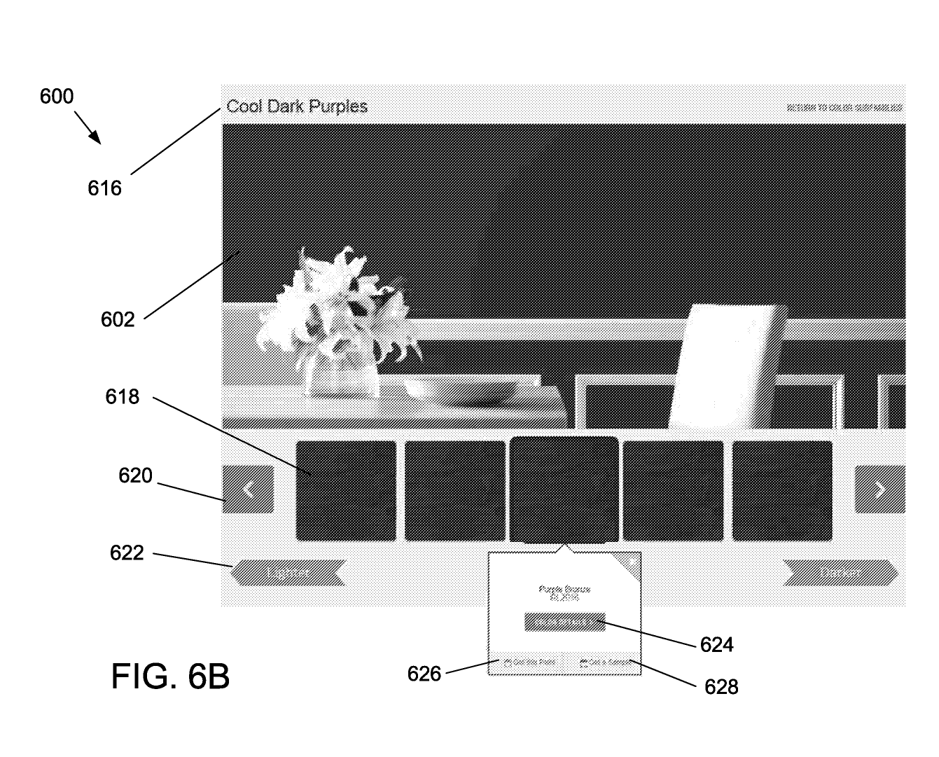

FIGS. 6A-6B show embodiments of exemplary modifiable image interfaces 600 presented to a user upon selecting one of the color option icons 500, as discussed above in step 180 of method 100 (see FIG. 1A). In the embodiment shown in FIG. 6A, a modifiable image 602 of a particular room, environment, or setting may be displayed to the user. In the embodiment shown, modifiable image 602 is colored in the paint color of the color option icon 500 selected by the user. Interface 600 also may display paint details 604 to the user. In the embodiment shown, paint details 604 include text listing the name 604n of the paint color and the paint brands 604b that carry that paint color. Interface 600 may also display color palette icons 606 to the user. Color palette icons 606 may function similarly to color palette icons 504. However, color palette icons 606 may be compiled using the paint color selected by the user as the main color 606p and using other accessory colors 606c that are aesthetically pleasing when combined with the selected paint color. Color palette icons 606 may be compiled by the paint brand 604b listed in paint details 604 or may be compiled by another entity.

The one or more software applications discussed above are configured such that the user may modify image 602 in a variety of ways. The user may select a change room icon 608 to modify the room type shown in image 602. The new image may be accessed from a collection of default images or a collection of custom images created by the user. The new room type will remain painted in the paint color selected by the user. In this way, the user may visualize how different types of rooms may look if painted in the selected paint color. The user may also modify the image 602 by selecting one or more colors from the color palette icons 606. For example, the user may select an accessory color 606c from one of the color palettes. This selection may modify image 602 to show the room type painted in the selected accessory color instead of the previous main color. The user may use these options to toggle between different room types and paint colors. In some embodiments, the user may select a change transparency icon 610 to modify the transparency of the coating color displayed in image 602. For certain material coatings, there may be different transparency levels, such as opaque, translucent, and transparent. Upon a selection of change transparency icon 610, the user may be presented with various transparency options corresponding to the available transparency levels for the coating. As the user selects the various transparency options, image 602 may display the corresponding transparency level. In some embodiments, a material coating has only a single transparency level. In these cases, image 602 may automatically display the single transparency level and change transparency icon 610 may be unavailable for selection. In some embodiments, scrolling buttons 612 may be provided to allow the user to quickly modify image 602 with different colors. The colors accessed by scrolling buttons 612 may be predetermined or determined by the user's browsing history. When the user desires to view purchase options for a particular paint, the user may select checkout icon 612 to move to a checkout interface.

In the embodiment shown in FIG. 6B, interface 600 shows a configuration that may be displayed when the user selects one of category icons 412, 414, 416, 418, 420 shown in FIG. 4C. Interface 600 may include modifiable image 602, color category text 616, and a plurality of individual color shade icons 618. Color category text 616 may display the color category corresponding to the category icon selected by the user from the embodiment shown in FIG. 4C. Color shade icons 618 may be arranged in any scrolling or toggle format. In the embodiment shown, color shade icons 618 are arranged in a carousel format that displays a plurality of color shade icons 618 to the user. The user may scroll through color shade icons 618 using scroll buttons 620 or other suitable toggling method. In the embodiment shown, color shade icons 618 are arranged in order from lighter shades to darker shades. The user may be informed of the order arrangement via color shade descriptors 622. This may assist the user to compare the characteristics of different color shades.

In the embodiment shown, when the user selects a color shade icon 618, image 602 displays a room colored in the paint color of the color shade icon 618 selected by the user. The user may change the color of image 602 by selecting different color shade icons 618. When the user selects a particular color shade icon 618, a pop-up box may appear to display selection option icons 624, 626, 628 to the user. The user may continue to explore additional details for the selected color by selecting color details icon 624. If the user selects color details icon 624, the user may move to an interface similar to the embodiment shown in FIG. 6A. The user may also view purchase options for paint in the selected color by selecting paint checkout icon 626 or sample checkout icon 628. Upon a selection of paint checkout icon 626, the user may be transferred to a checkout interface for purchasing the displayed paint. Upon selection of sample checkout icon 628, the user may be transferred to a checkout interface for receiving a sample of the displayed paint. In some embodiments, the sample may be purchased or may be free to the user. The embodiments shown in FIGS. 6A-6B may be modified based on other material coatings. For example, image 602 may display an environment other than a painted room, such as a lacquered wood floor having a particular type of sheen or tone. Details 604 may be lacquer details instead of paint details and palette icons 606 may show complementary lacquer types instead of complementary paint colors.

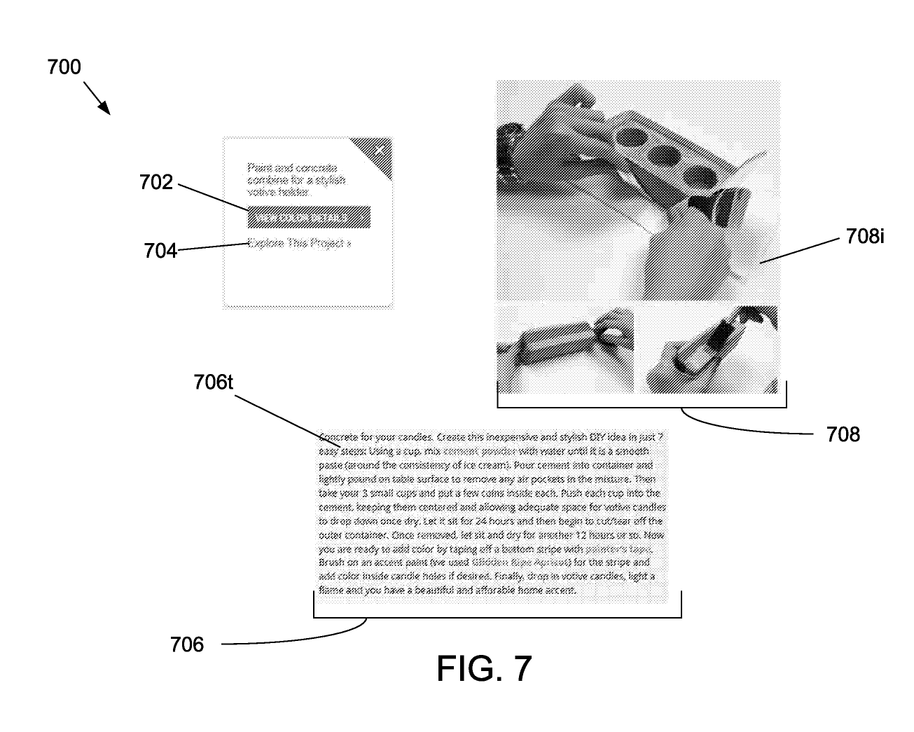

FIG. 7 shows an embodiment of exemplary project interface option icons 700 that may be displayed when the user selects one of the object or project icons 410 shown in FIG. 4B. In the embodiments shown, the user may be presented with color details icon 702 and explore project icon 704. Some of the object or project choices represented by icons 410 (see FIG. 4B) may only display one of icons 702 and 704. If the user selects color details icon 702, the user may move to an interface similar to the embodiment shown in FIG. 6A. If the user selects explore project icon 704, the user may move to an interface displaying instructions for completing the project represented by the selected project icon 410 (see FIG. 4B). This project interface may be a part of the same interface as the embodiments of FIGS. 2A-6B discussed above. In other embodiments, the project interface may be a separate interface, such as a separate web page from a web page containing the embodiments of FIGS. 2A-6B.

Project instructions may include an instruction field 706 containing textual instructions 706t and an image field 708 containing one or more illustrative images 708i. Textual instructions 706t may guide the user to complete the project in a step-by-step progression. Images 708i may illustrate images of the project at different steps of the textual instructions 706t to assist the user in completing the project. For example, if the user selected a concrete candle votive icon 410 in the embodiment shown in FIG. 4B, the user may be taken to a web interface containing textual instructions 706t and illustrative images 708i shown in FIG. 7. In some embodiments, other information may be included as project interface option icons 700. For example, the user may also be presented with recommendations for colors or color palettes that may integrate the color of the project with the user's overall color preferences.

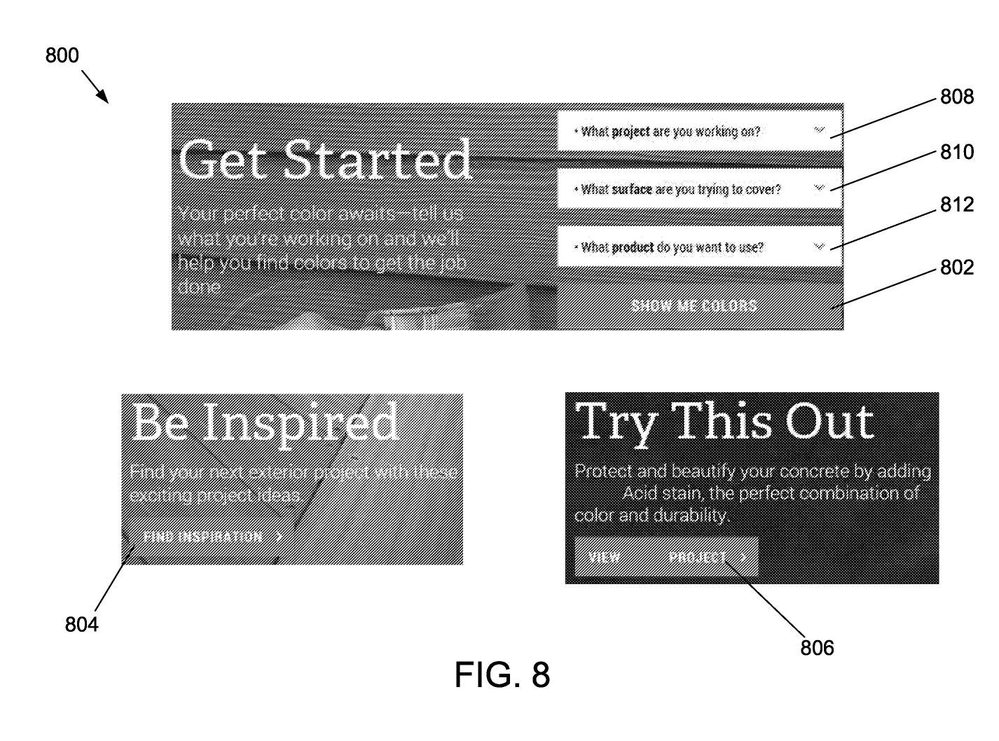

FIG. 8 shows an embodiment of exemplary selectable option icons 800 that may be presented to a user, as discussed above in step 120 of method 100 (see FIG. 1A). In some embodiments, selectable option icons 800 may be presented to the user upon selection of exterior coating option icon 203 shown in FIG. 2. In the embodiment shown in FIG. 8, selectable option icons 800 may include color recommendation option icon 802, color inspiration option icon 804, and project recommendation option icon 806. In some embodiments, the functionality triggered by a user selection of color recommendation option icon 802 may be similar to that triggered by a user selection of option icon 301 in FIG. 3A, and allow the user to navigate hierarchical menu levels to find recommendations for colors matching various categories. The functionality triggered by a user selection of color inspiration option icon 804 may be similar to that triggered by a user selection of option icon 303 in FIG. 3B, and allow the user to navigate hierarchical menu levels to find decoration ideas by browsing through various outdoor settings and objects decorated in different color schemes. The functionality triggered by a user selection of project recommendation option icon 806 may allow a user to browse various outdoor projects and appropriate coating recommendations for completing the projects.

In the embodiment shown, the functionality triggered by a user selection of color recommendation option icon 802 may allow the user to search for particular coating types and colors by specifying project criteria. The user may select a type of project from project dropdown menu 808, a type of surface from surface dropdown menu 810, and a type of product from dropdown menu 812. After making selections from each of dropdown menus 808, 810, 812, the user may select color recommendation option icon 802 to move to an interface displaying various color and product recommendations tailored to the user's project criteria. For example, the user may want to view recommendations for stains appropriate for coating an outdoor wooden deck. The user may select appropriate criteria from dropdown menus 808, 810, 812 select icon 802 to see the recommendations.

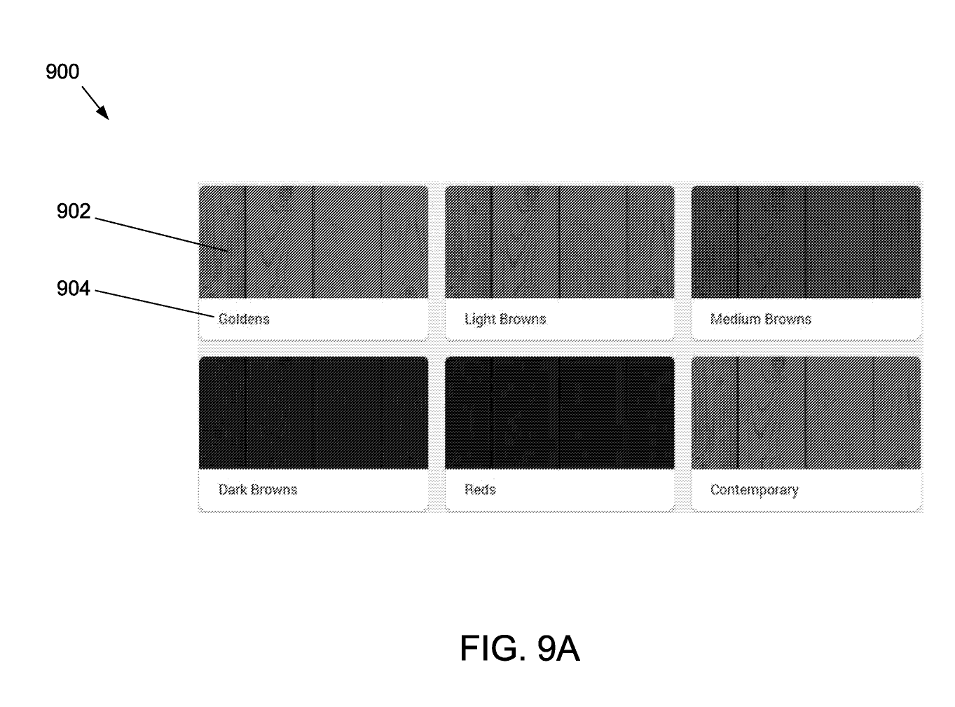

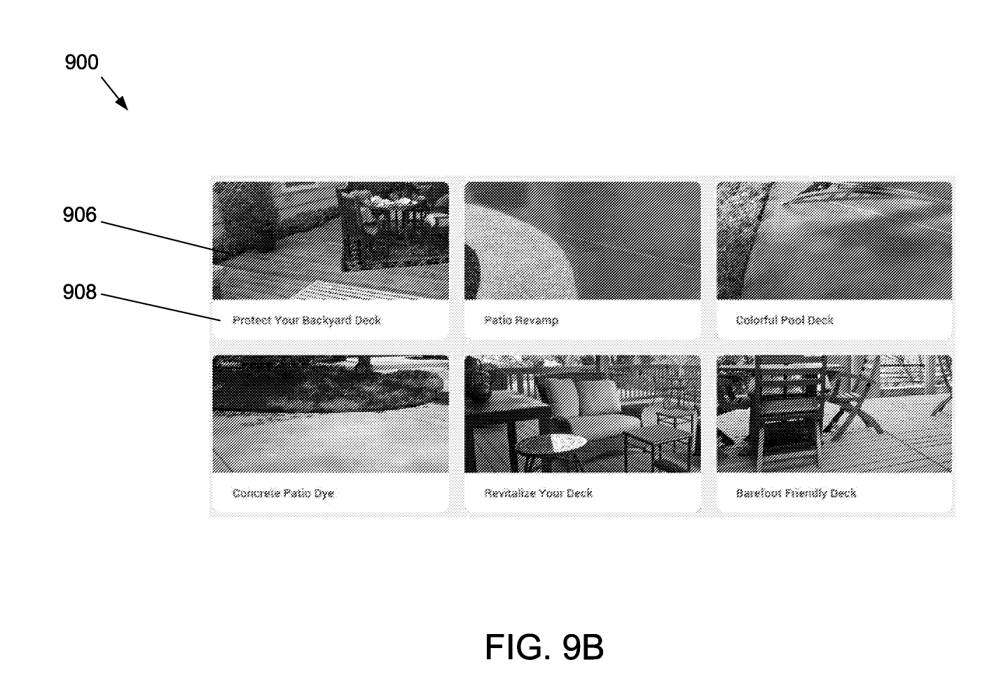

In the embodiment shown in FIG. 9A, the functionality triggered by a user selection of selectable option icons 900 may allow the user to search for a color based on a color and/or style family. Icons 900 may include an image 902 and a textual descriptor 904 displaying an exemplary color tone and description corresponding to a color/style family. In the example shown, option icons 900 correspond to stain colors appropriate for coating an outdoor wooden deck based on the project criteria entered in the embodiment shown in FIG. 8.

In the embodiment shown in FIG. 9B, the functionality triggered by a user selection of selectable option icons 900 may allow the user to view various outdoor project categories to assist the user to find the necessary products to complete a desired project. In some embodiments, icons 900 in FIG. 9B may be displayed upon a user selection of color inspiration option icon 804 or project recommendation option icon 806 shown in FIG. 8. Icons 900 may include an image 906 and a textual descriptor 908 displaying an exemplary scene and description corresponding to a particular outdoor project. A more narrowed set of icons 900 may be displayed upon selection of project recommendation icon 806 that may be pre-matched to a particular color, type, and/or brand of coating to allow the user to receive expedited recommendations.

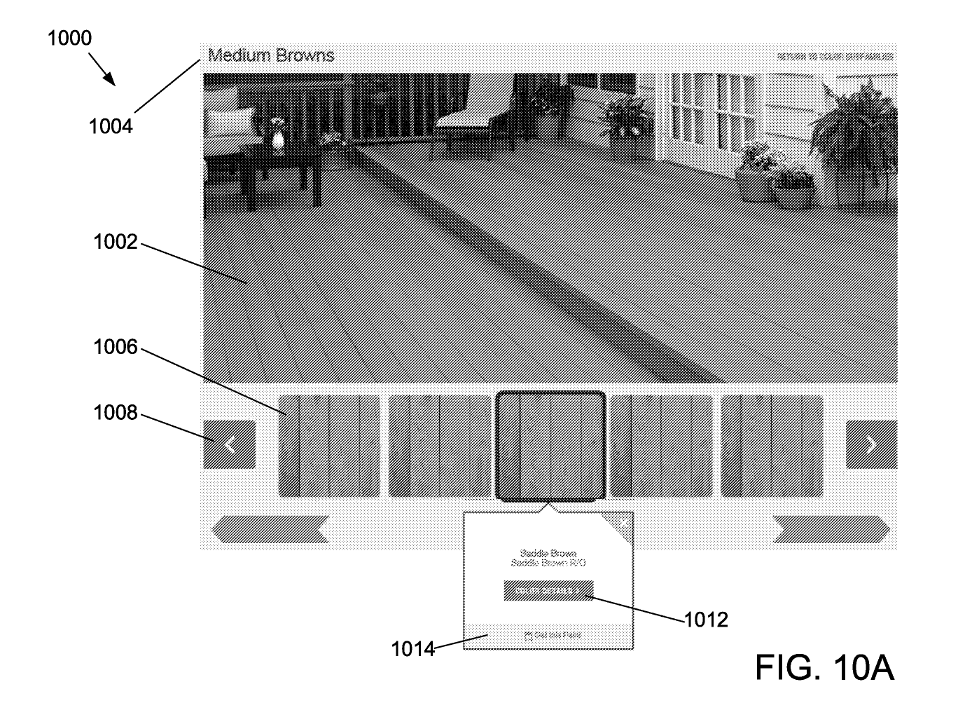

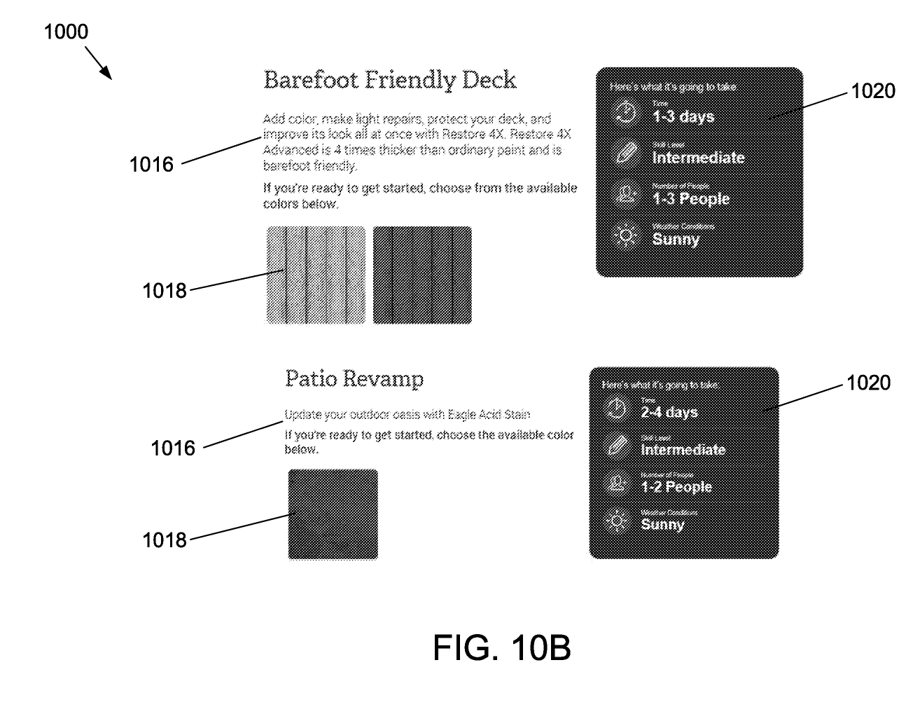

FIGS. 10A-10B show embodiments of exemplary modifiable image interfaces 1000 presented to a user upon selecting one of the option icons 900 shown in FIG. 9A. In the embodiment shown in FIG. 10A, interface 1000 shows a configuration that may be displayed when the user selects an icon 900 corresponding to one of the color/style families shown in FIG. 9A. Interface 1000 may be similar to interface 600 shown in FIG. 6B. Interface 1000 may include modifiable image 1002, color category text 1004, and a plurality of individual color shade icons 1006 that may be arranged in any scrolling or toggle format. The user may scroll through color shade icons 1006 using scroll buttons 1008 or other suitable toggling method.

In the embodiment shown, when the user selects a color shade icon 1006, image 1002 displays an exemplary image colored in the paint or stain color of the color shade icon 1006 selected by the user. The user may change the color of image 1002 by selecting different color shade icons 1006. When the user selects a particular color shade icon 1006, a pop-up box may appear to display selection option icons 1012, 1014 to the user. The user may continue to explore additional details for the selected color by selecting color details icon 1012. If the user selects color details icon 1012, the user may move to an interface similar to the embodiment shown in FIG. 6A but geared toward exterior images and coatings. The user may also view purchase options for paint in the selected color by selecting paint checkout icon 1014. Upon a selection of paint checkout icon 1014, the user may be transferred to a checkout interface for purchasing the displayed paint.

In the embodiment shown in FIG. 10B, interface 1000 may display recommendations to the user corresponding to the project icon 900 selected in FIG. 9B. The recommendations may include descriptive text 1016 of products and projects, color icons 1018 that display available color options for the project, and project summary 1020 that displays—via text, graphics, or a combination of both—certain project attributes, such as one or more of an estimated time, skill level, manpower, and weather conditions recommended to complete the project.

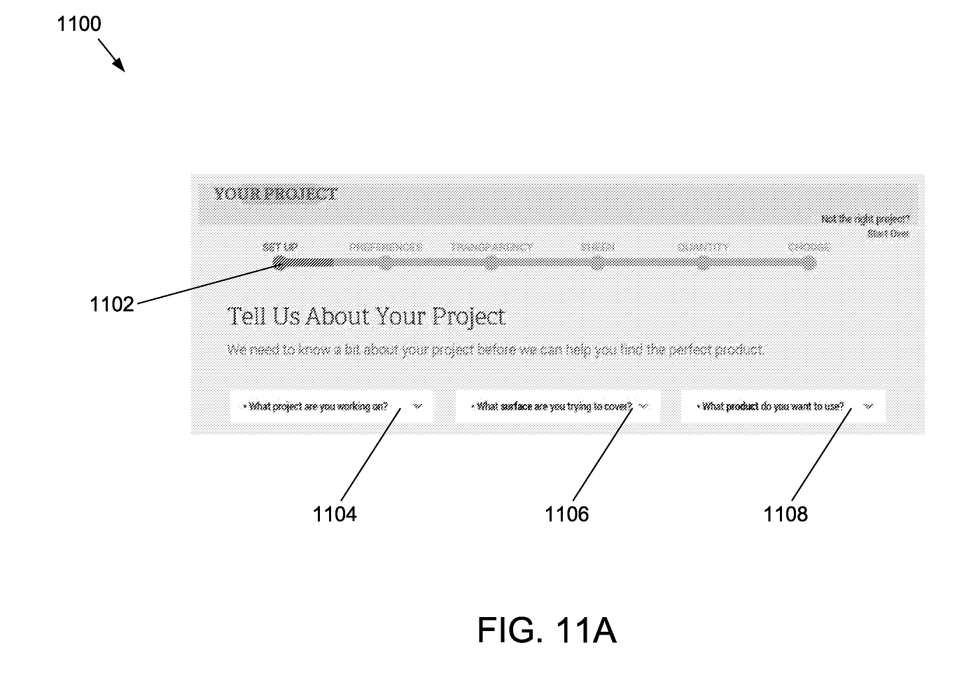

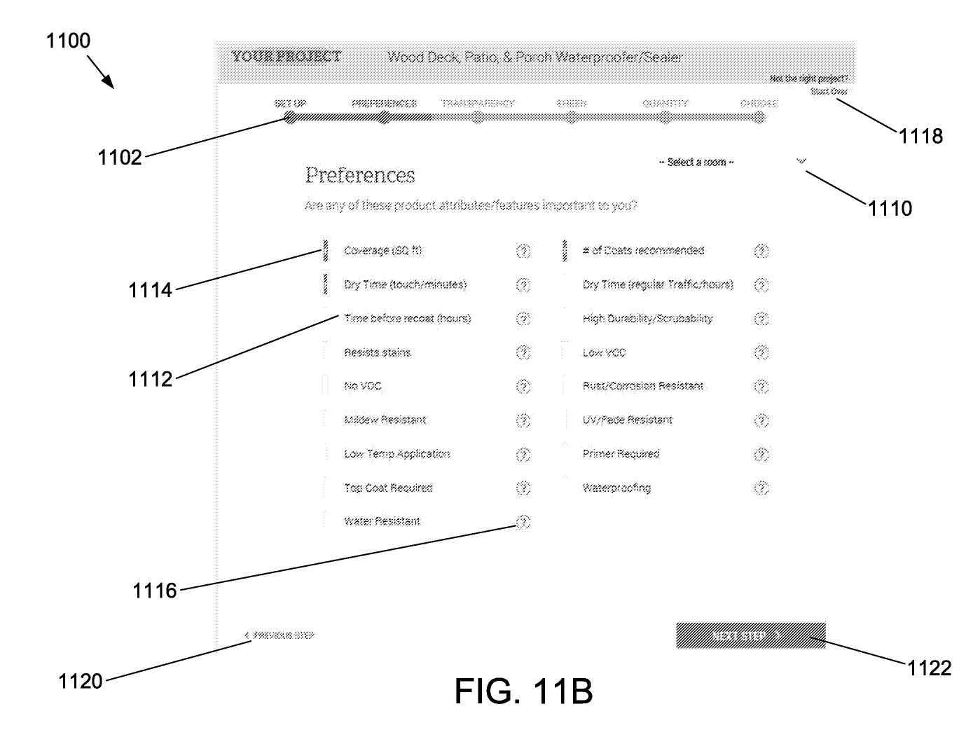

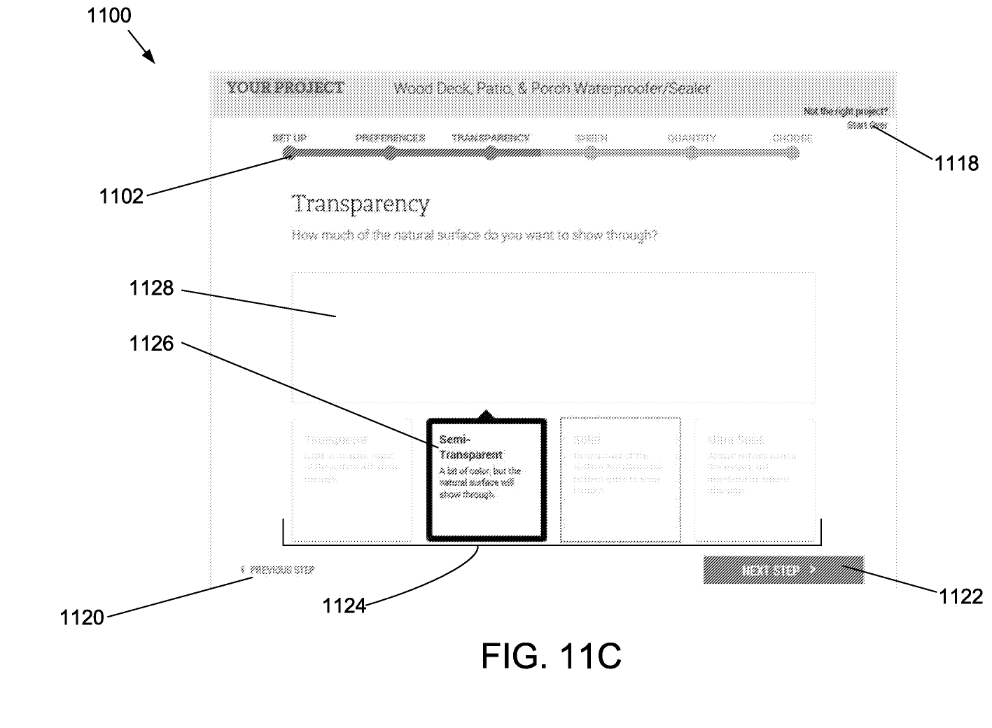

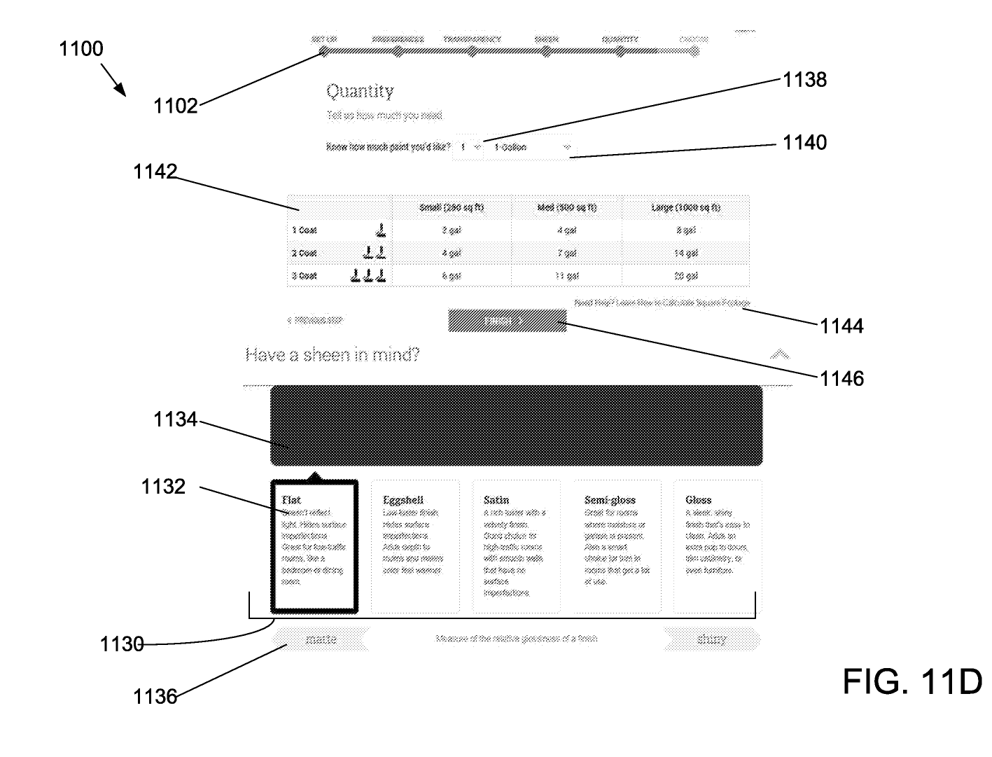

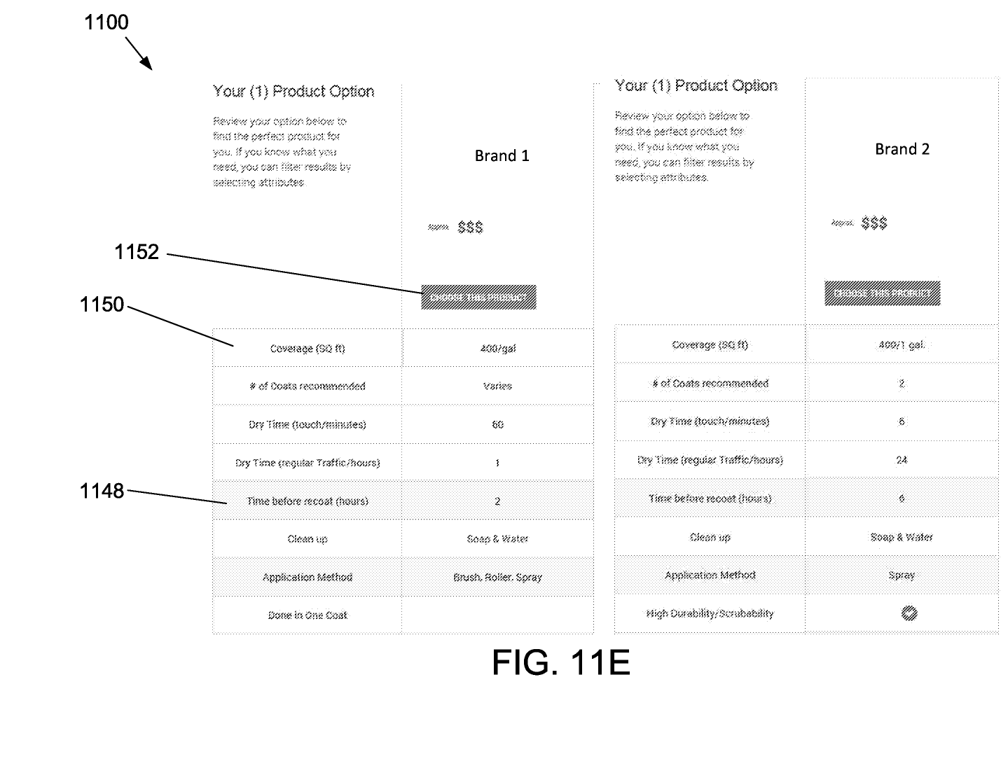

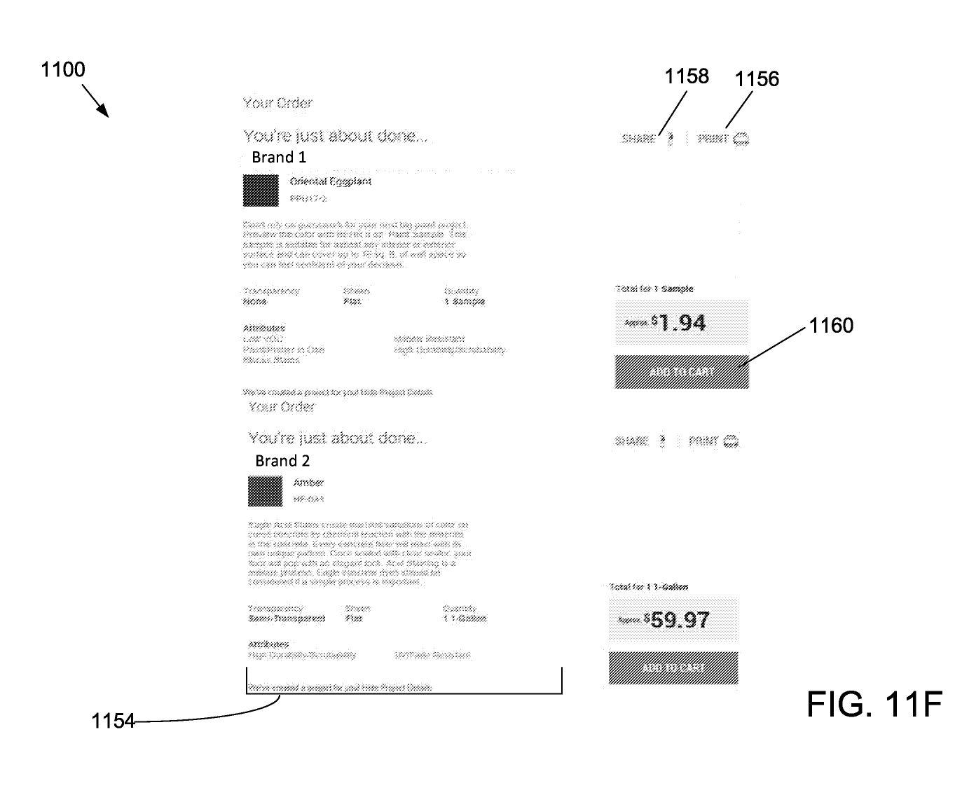

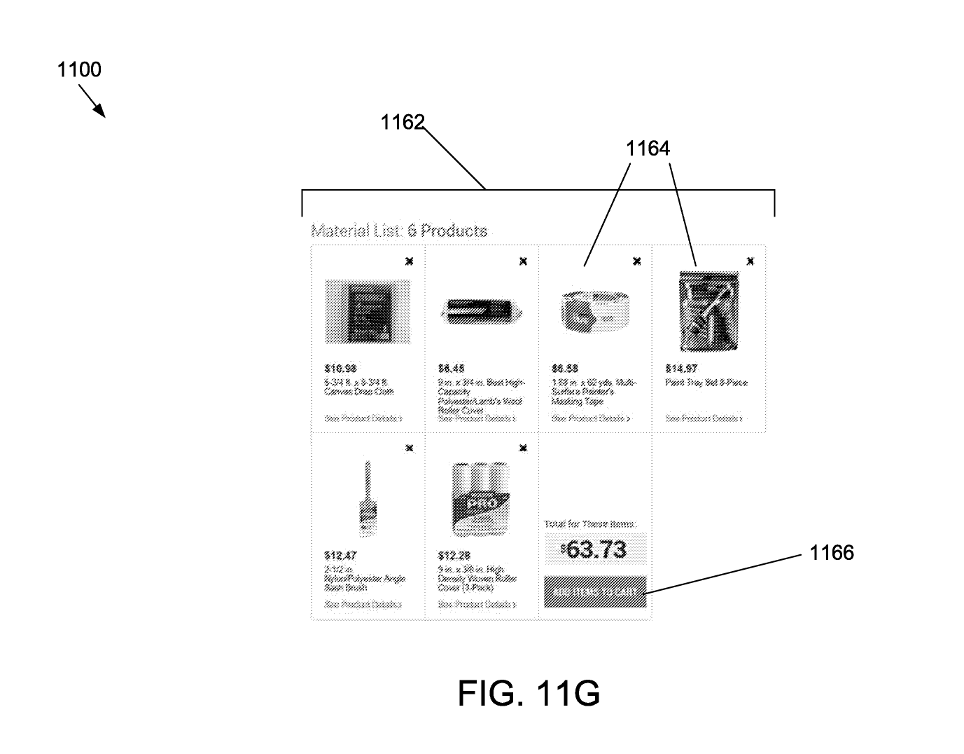

FIGS. 11A-11G show embodiments of exemplary checkout option interfaces 1100 that may be presented to the user upon selecting any of the checkout icons disclosed in the previous figures. In the embodiment shown in FIG. 11A, checkout option interface 1100 may comprise a breadcrumb bar 1102 and dropdown menus 1104, 1106, 1108. Breadcrumb bar 1102 may inform the user of his location in the checkout process. In some embodiments, breadcrumb bar 1102 may be selectable to allow the user to navigate through checkout steps. The user may enter a project type into project dropdown menu 1104, a surface type into surface dropdown menu 1106, and a product type into product dropdown menu 1108. In some embodiments, dropdown menus 1104, 1106, 1108 may already be populated with information corresponding to prior user selections.

In the embodiment shown in FIG. 11B, interface 1100 may be shown after the user enters information into the interface shown in FIG. 11A. In the embodiment shown, breadcrumb bar 1102 shows that the user is progressing through the checkout process. In some embodiments, a dropdown menu 1110 may be provided that allows the user to select a particular room or exterior environment that the user desires to coat. The type of categories in the dropdown menu 1110 may correspond to whether the user is exploring interior or exterior coatings. A list of preferences 1112 may be displayed to the user. In some embodiments, preferences 1112 may be tailored to the project criteria specified in FIG. 11A. Preferences 1112 may be further tailored based on a user selection from dropdown menu 1110. For example, if the user selects “Living Room” from dropdown menu 1110 in the embodiment shown in FIG. 11B, the preferences 1112 displayed may be preferences specifically applicable to painting living rooms. The user may select one or more preferences 1112 that are important to the user by clicking a selection box 1114 corresponding to the desired preference. The user may select information icon 1116 to display text describing attributes related to the corresponding preference. These attributes may assist the user in deciding preferences to select. The product recommendations may be tailored to the preferences specified by the user. The user may select all, some, or none of the preferences. If the user does not select any preferences 1112, the product recommendations may follow a default setting. At any point in the process, the user may select restart icon 1118 to restart the checkout process from the beginning or may select previous page icon 1120 to return to the previous step in the checkout process. The user may select next step icon 1122 to proceed to the next step in the checkout process.

In the embodiment shown in FIG. 11C, transparency option icons 1124, transparency descriptors 1126, and modifiable transparency image 1128 may be displayed. In the embodiment shown, the user may choose a transparency option by selecting one or more transparency option icons 1124. Transparency option icons 1124 may contain textual descriptors 1126 that may include a transparency category, a brief description of that transparency, and some examples of common uses for that transparency. Transparency option icons 1124 may be arranged in order from least transparent to most transparent. Modifiable transparency image 1128 may change to display the transparency corresponding to the currently selected transparency option icon 1124. For example, if the user selects a semi-transparent option, image 1128 may display a semi-transparent coating. If the user selects another transparency, image 1128 may change to display the newly selected transparency. These options may assist the user to compare the characteristics of different transparencies. In some embodiments, coatings may only have a single transparency. In these cases, interface 1100 shown in FIG. 11C may be unavailable and may be skipped as the user proceeds through the checkout process represented by breadcrumb bar 1102.

In the embodiment shown in FIG. 11D, color sheen option icons 1130, color sheen descriptors 1132, and modifiable color sheen image 1134 may be displayed. In the embodiment shown, the user may choose a color sheen option by selecting one or more color sheen option icons 1130. Color sheen option icons 1130 may contain textual descriptors 1132 that may include a color sheen category, a brief description of that color sheen, and some examples of common uses for that color sheen. Color sheen option icons 1130 may be arranged in order from matte to glossy sheens. The user may be informed of the order arrangement via color sheen order descriptors 1136. Modifiable color sheen image 1134 may change to display the color sheen corresponding to the currently selected color sheen option icon 1130. For example, if the user selects a flat option, image 1134 may display a coating colored with a flat sheen. If the user selects another color sheen option, image 1134 may change to display the newly selected color sheen. These options may assist the user to compare the characteristics of different color sheens for a particular color coating. In some embodiments, coatings may only have a single color sheen. In these cases, interface 1100 shown in FIG. 11D may be unavailable and may be skipped as the user proceeds through the checkout process represented by breadcrumb bar 1102. In some embodiments, the checkout process may be tailored to the type of coating selected. For example, an interior paint may have multiple color sheen options but only a single transparency option while a waterproof sealant may have multiple transparency options but no color sheen options.

Interface 1100 of FIG. 11D further shows a variety of selectable quantity options, such as unit quantity option icon 1138, container size option icon 1140, recommendation table 1142, and paint calculator option icon 1144. In the embodiment shown, the user may choose a paint unit quantity by selecting unit quantity option icon 1138. The user may type a particular unit quantity into a quantity field or may select a unit quantity from a dropdown menu. Similarly, the user may choose a paint container size by selecting container size option icon 1140. The user may type a particular container size into a container size field or may select a container size from a dropdown menu. The user may determine the quantity and container size needed by consulting references table 1142. Reference table 1142 may display quantity recommendations based on a number of coats desired and a size of the area to be coated. In the embodiment shown, the user may select paint calculator option icon 1144 for assistance in determining an appropriate unit quantity and container size for desired projects. The user may enter project description information, room or object dimension information, and/or other descriptive information. The paint calculator may make unit quantity and container size recommendations based on the entered description information. In some embodiments, the paint calculator may make recommendations that are cost effective for the user. For example, if the user wants to paint a living room, the paint calculator may recommend larger container sizes that may have a cheaper unit price over smaller container sizes that may have a more expensive unit price. After selecting the desired quantity options, the user may continue the checkout process by selecting a finish icon 1146.

In the embodiment shown in FIG. 11E, interface 1100 may display one or more recommended coating products based on the user's inputted criteria when the user selects finish icon 1146 (see FIG. 11D). In the embodiment shown, the coating products may display coating attributes 1148 and preferred coating attributes 1150. When the user selects one or more preferences 1112 in the embodiment shown in FIG. 11B, preferred coating attributes 1150 may be highlighted to quickly point out these important attributes to allow the user to more easily choose a coating product. For convenience and comparison purposes, the coating products and their respective attributes may be displayed close to each other so the user can compare and contrast the coating products. The user may select one of icons 1152 for the coating product the user wishes to buy to view additional information about that coating product.

In the embodiment shown in FIG. 11F, coating product detail field 1154 may be displayed when the user selects one of icons 1152. Coating product detail field 1154 may include description text that may describe a price quote based on the paint color, paint brand, paint attributes, desired paint quantity, desired container size, and desired transparency and color sheen options selected by the user. The description text—may correspond to the selections the user made in the embodiments shown in FIGS. 11A-11D. In the embodiment shown, the user may print and/or share the price quote by selecting print icon 1156 or share icon 1158, respectively. The share icon 1158 may allow the user to email the price quote or share via SMS and/or other messaging protocols and social media platforms. In other embodiments, the user may save the quote to a memory device or a memory cloud. In this way, the user may create and save a plurality of price quotes to aid the user in a coating purchase decision. The user may add coating products to a cart for checkout by selecting one or more cart icons 1160.

In the embodiment shown in FIG. 11G, supplemental product recommendation field 1162 may also be provided when the user selects one of cart icons 1160. Supplemental product recommendation field 1162 may display one or more products 1164 that may be recommended for a particular coating project such as drop cloths, paint rollers, and masking tape as well as their respective prices and a price total. The user may keep or remove any of these products 1164. If the user removes a product 1164, the price total may be adjusted accordingly. The user may add the recommended products to his shopping cart by selecting one or more of cart icons 1166. The user may then access an online purchase page to purchase items in the shopping cart. The embodiments shown in FIGS. 11A-11G may be tailored to display options for various types of material coatings such as paints, stains, sealants, varnishes, and lacquers.

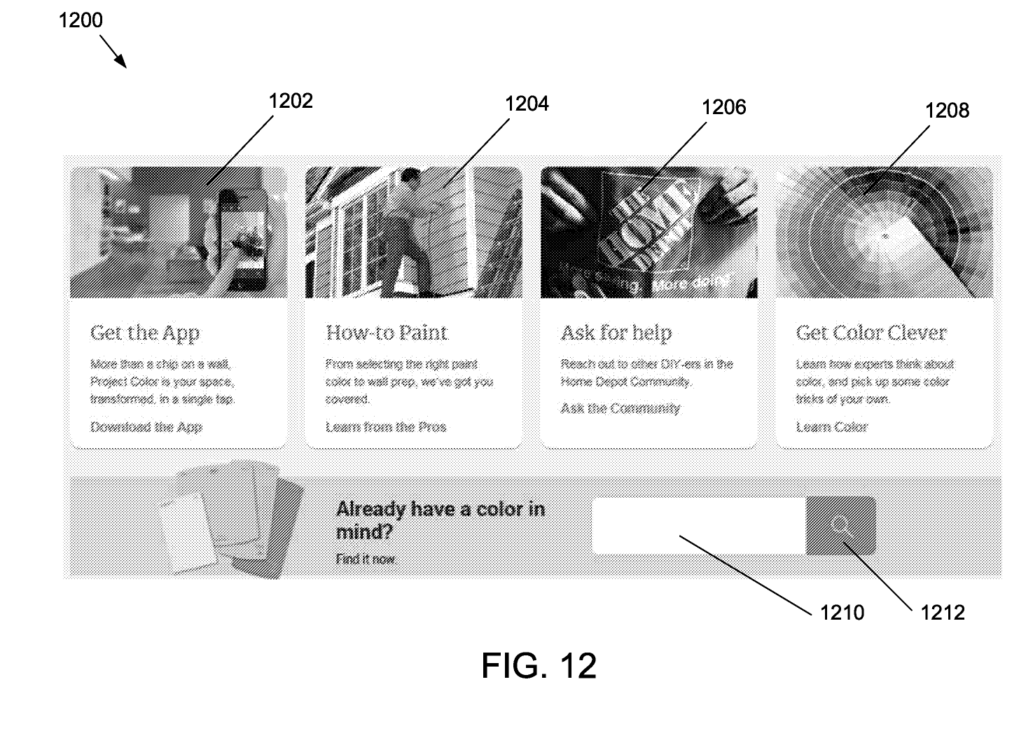

In the embodiment shown in FIG. 12, interface 1200 may display a mobile application option icon 1202, a variety of instructional option icons such as a video tutorial option icon 1204, online community option icon 1206, and color theory option icon 1208, and a text search option or field. The options of interface 1200 may be displayed simultaneously with one, some, or all of the interfaces disclosed above. Upon a selection of mobile application option icon 1202, the user may access an interface that allows him to download a mobile application corresponding to the embodiments described herein. The mobile application may be compatible with various types of mobile devices and operating systems. Upon selection of video tutorial option icon 1204, the user may access an interface having multiple selectable video tutorials allowing the user to learn about various coating projects. Upon selection of online community option icon 1206, the user may access an online community to ask questions, find answers, and discuss project topics. Upon selection of color theory option icon 1208, the user may access information about color theory to assist the user to put together his own color palettes and ideas. If the user has a specific color in mind, the user may input search text into text box 1210 and select search icon 1212 to search a coating product database for that particular color. Coating types, sheen types, transparency types, brand types and other category terms may also be inputted to assist in narrowing the user's search.

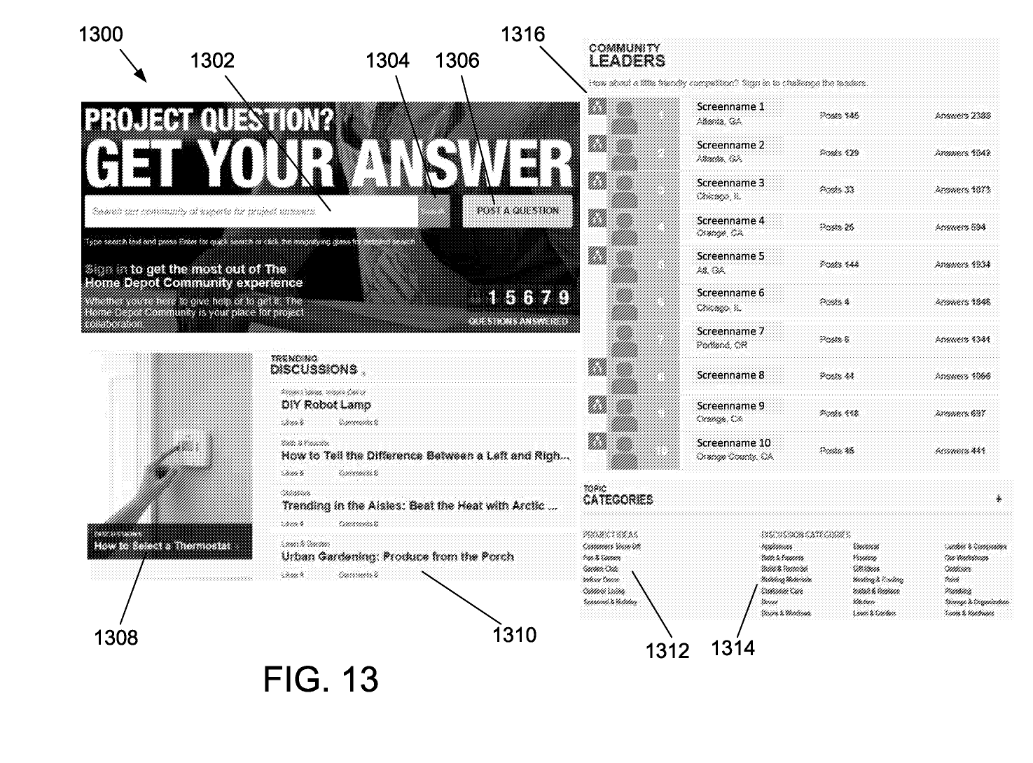

In the embodiment shown in FIG. 13, online community interface 1300 may be displayed. In some embodiments, online community interface 1300 may be displayed upon selection of online community option icon 1206 shown in FIG. 12. In some embodiments, the resources of online community interface 1300 may be accessed without a user profile while in other embodiments, the user may register a profile and log in to the profile to access the community resources. The user may use a text search by entering search terms in a search text box 1302 and selecting a search icon 1304. The user may use the text search to directly find community resources related to particular topics, products, and/or projects. The user may also select question icon 1306 to post a question to the community. In some embodiments, after selecting question icon 1306, the user may begin a new discussion thread or post a reply to an existing thread. In some embodiments, the user may direct a question to a particular expert or group of experts in a field correlating to the subject matter of the question. In addition to text searching, the user may browse and access community resources with other options.

In some embodiments, the user may select a discussion image 1308 related to a particular project or topic. The topic may be a topic of frequently asked questions, a topic of recent interest by the community, or a random topic chosen at preset intervals. The user may also access a trending topic list 1310 to view topics of recent interest to the community. The user may browse through the discussion threads to view questions, answers, instructions, and other information relevant to the topic of the thread selected. The topics in trending topic list 1310 may be updated at preset intervals, upon a browser refresh, in real time, or at various other intervals. In some embodiments, the user may search for discussion threads by selecting a category from project ideas list 1312 or discussion category list 1314. Each entry in project idea list 1312 and discussion category list 1314 may comprise a link that may take the user to one or more discussion threads related to that project idea or discussion category. These options may be useful if the user does not have enough information to perform a text search but desires a more direct option than browsing through discussion threads or waiting for a posted question to be answered. In some embodiments, a community leaders list 1316 may be displayed to the user. Community leaders list 1316 may display a list of experts and/or other community users that lead the community in various categories. In the embodiment shown, the list may be sorted by the number of questions answered or by the number of posts made to discussion threads in the online community. In some embodiments, the entries in community leaders list 1316 may contain a photo or avatar corresponding to the expert or user, the expert's name, location, and community statistics, and one or more links for contacting the expert or user to ask a question or accessing the expert's posts and/or answers.

Additional functionalities may supplement the methods and systems disclosed in the embodiments above. In some embodiments, the user may initiate method 100 or access network system 105 by logging into a personal profile. The personal profile may include a plurality of personal information such as user identification information, user preference information, and user financial information. The user may also customize the personal profile to connect to various storage media and/or social networking applications. By using a personal profile, the user may be able to customize his experience by performing functions such as uploading pictures, saving price quotes, and sharing project information.

In some embodiments, the user may upload a custom image of a room, object, or other environmental setting to use instead of default images 602 shown in FIGS. 6A-6B. For example, the user may take a photo of his living room on a mobile device and upload the photo to his personal profile from the mobile device's camera roll or other image storage application. It may be recognized that other types of upload operations may be used. Once the photo is uploaded, modifiable image 602 may display the user's living room instead of a default image. The user may then use the functionalities disclosed above to modify the color of image 602 to get an idea of how particular paint colors may look in his personalized living space. This may include one or more of adjusting the sheen, transparency, or finish of the paint color displayed in image 602.

In some embodiments, the user may access functions that allow the user to select various lighting effects for image 602. These lighting effects may be useful to allow the user to visualize how a particular paint color may look under different lighting conditions. The lighting effects may represent natural daylight at different times of the day and/or represent artificial lighting of differing intensities and angles. In some embodiments, the initial light levels of image 602 may be maintained or kept intact. For example, if the user took a photo of his living room at 11:00 AM, the natural light occurring in the photo would be kept intact and would not change based on other light modifications performed by the user. These lighting effects may be used in conjunction with other selections (e.g., paint color, sheen, etc.) to modify image 602 to display an exemplary scene corresponding to the user's choices. The lighting effect choices may be displayed to the user in any suitable manner such as a dropdown menu or an array of selectable icons.

In some embodiments, the user may access functions that allow the user to selectively paint different elements of image 602. This may be accomplished by using machine vision or other masking technology applications. In this way, the user may select certain objects of image 602 to color them in different paint colors. For example, with reference to image 602 in the embodiment shown in FIG. 6A, the user may select the rightmost wall to be colored green and may select the leftmost wall to be colored brown. The user may also use a masking function to select the bath towel in image 602 so the bath towel would maintain its existing color and not be “painted over” with the selected brown color of the leftmost wall. In some embodiments, the masking function may be used in conjunction with each selection option provided by the system (i.e., paint color, lighting, sheen, etc.).

In some embodiments, the user may access functions to save various renditions of image 602, paint details 604, color palette icons 606, and other various elements shown in FIGS. 2A-11G and described herein. As the user changes the various selection options, the user may save versions of the modified image 602 to a memory device or memory cloud. In some embodiments, the user may share various renditions of image 602 and/or other various elements shown in FIGS. 2A-11G and described herein via email, SMS/text messaging, and/or social networking applications such as Facebook®, Twitter®, or Pinterest®. In some embodiments, the user may access an image compare function. The image compare function may allow the user to display one or more images having different characteristics in a close proximity for comparison. For example, the user may view an image showing his living room painted navy blue with overhead lighting next to an image showing his living room painted royal blue with lamp lighting. In this way, the user may compare images having different properties such as colors, finishes, sheens, transparencies, and lighting conditions. In some embodiments, the images may be stored in a small size or low resolution format and displayed in format allowing for easy selection by the user. For example, the images may be ordered in a scrollable carousel configuration similar to color shade icons 612 of FIG. 6B. In other embodiments, the images may be displayed in a thumbnail grid or other suitable display that allows the user to view multiple images. The user may select one or more of the thumbnail images to enlarge them for use in an image comparison function.

In some embodiments, the user may access functions that may automatically match a color of an image or a portion of an image with a particular paint color available for purchase. The user may select a portion of the image showing the color to be matched. The system may perform spectrophotometric analysis of the color in the image. The system may access a spectrophotometric database of paint colors and compare the spectrophotometric properties of the color in the image with the spectrophotometric properties stored in the database. In this way, the system may find a paint color from the database that most closely matches the color in the image. Once a suitable match is found, the system may recommend one or more paint colors and brands to the user. In some embodiments, the user may use the recommended color to modify various versions of image 602 In some embodiments, the system may not have a color that exactly matches the color in the image. In this case, the system may allow the user to create a new, custom color name for reference.

The results of the spectrophotometric analysis described above may be used in other ways. In some embodiments, the system may return color recommendations based on the colors analyzed in the image. The color recommendations may include a suggestion of alternate shades of the colors analyzed in the image. The color recommendations may also include additional colors that may coordinate with the colors analyzed in the image. In this way, the user may be able to access recommendations similar to those shown in FIGS. 6A-6B for customized images instead of default images 602. For example, the user may upload an image of his bedroom, which may have navy blue walls and forest green blankets on the bed. After a spectrographic analysis of the colors contained in the bedroom image, the system may return color recommendations for alternate shades of blue and green. Additionally, the system may also return color recommendations that complement and coordinate with the navy blue walls and forest green blankets on the bed.

In some embodiments, the user may customize an existing color palette or build a new color palette. In some embodiments, the user may modify a recommended color palette such as those displayed in FIG. 6A. The user may also build a new color palette based on a selected color from the color database or a color resulting from a spectrophotometric analysis of a photo, video, or other medium. The system may assist the user in creating the new color palette by providing recommendations and options based on the color provided. In some embodiments, the user may name, save, share, and categorize the personalized color palettes in the personal profile discussed above or via other media.

In some embodiments of a mobile application, the user may access functions that provide an augmented reality interface for real time modifications of paint colors and other attributes disclosed above. The augmented reality interface may be used with recorded videos. The augmented reality interface may also be used with a live environment captured by a camera of a mobile device or other suitable image capturing means. Using the camera on the mobile device, the user may pan around a room or other setting and view the captured live feed on the screen of the mobile device. The captured image may be integrated with the augmented reality interface to allow the user to select various options and modify the live image in real time. For example, the user may stand in his living room and view a live feed of a living room wall on the screen of his mobile device that is captured by the mobile device's camera. As the user views the live feed of the wall, various selectable options may be displayed in an augmented reality interface overlaid onto the image on the screen. The selectable options may be arranged in icon format, menu format, list format, or other suitable option display format. When the user chooses a particular option, the augmented reality interface may modify the live image of the wall to correspond to the selected option. For example, if the original wall color is brown, the user may select a green color option from the augmented reality interface to view the live image of the wall with a green color. The options available in the augmented reality interface may be similar to the options discussed above, such as paint color, lighting, and sheen options. As the user modifies the live image via the augmented reality interface, the user may save various versions of the image in photo or video format. These stored versions of the image may be uploaded and used as image 602 as discussed above.

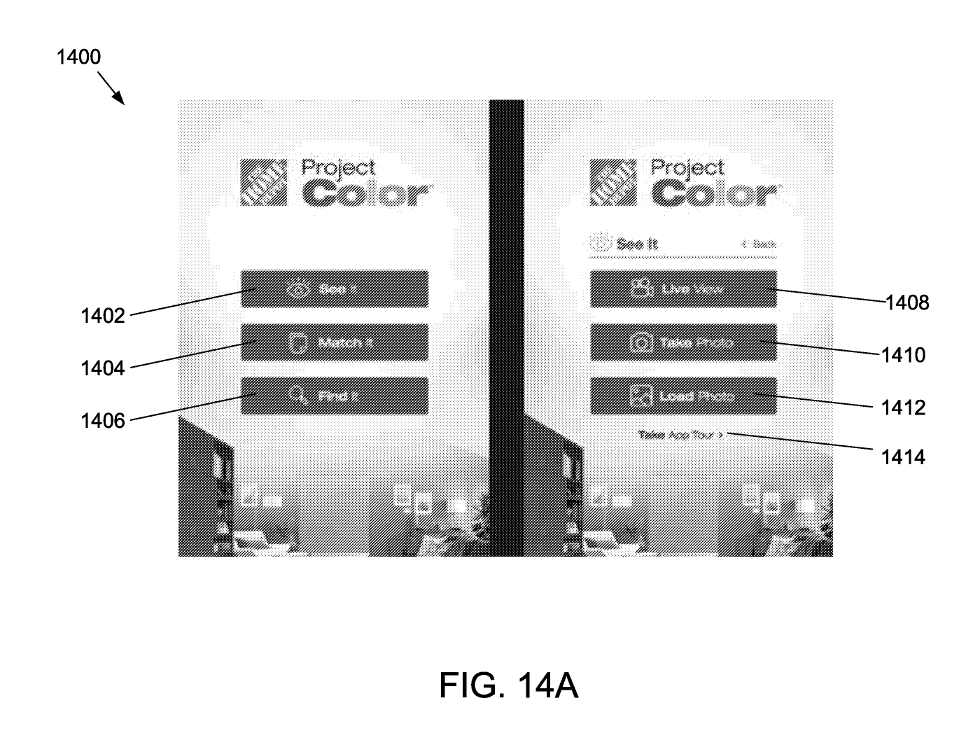

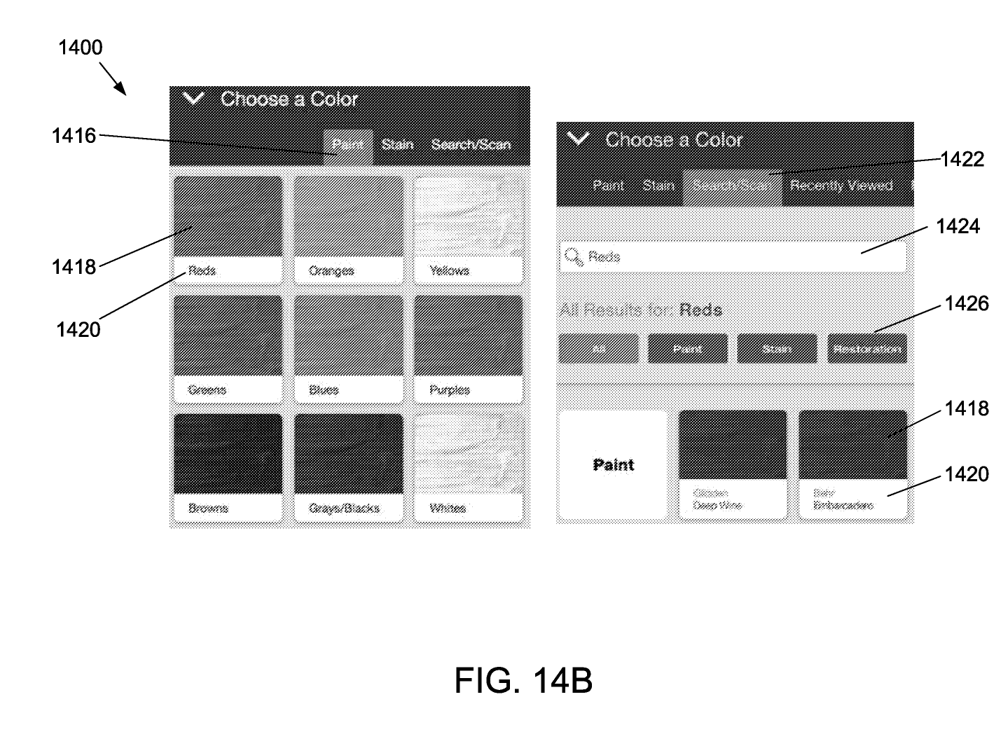

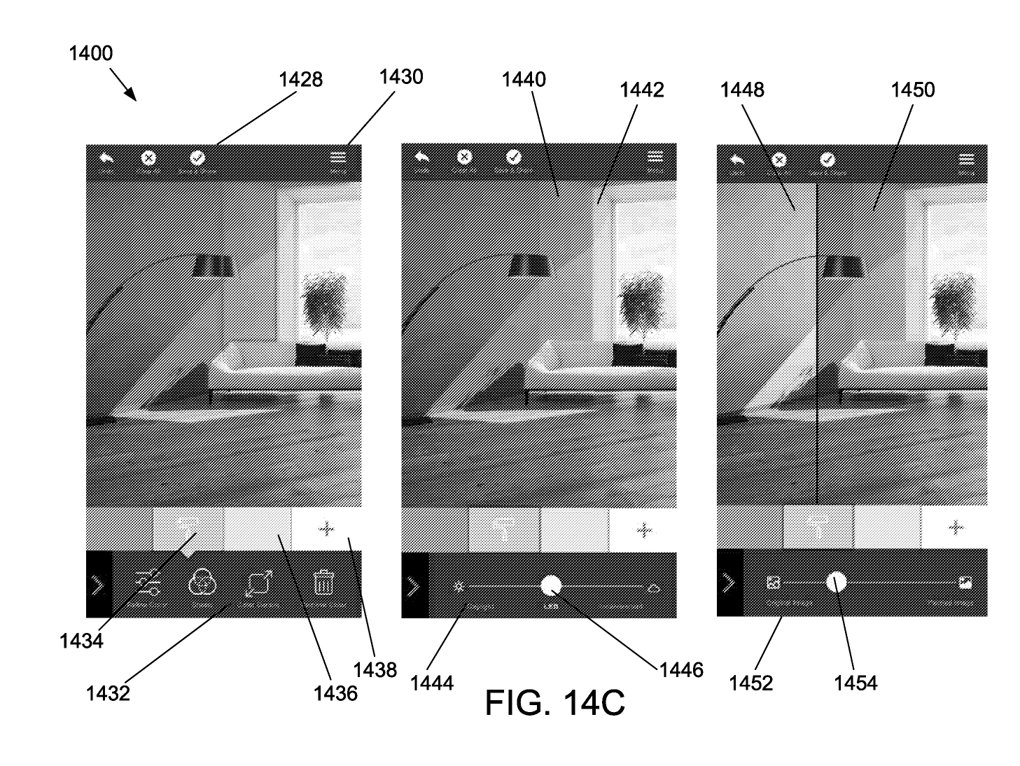

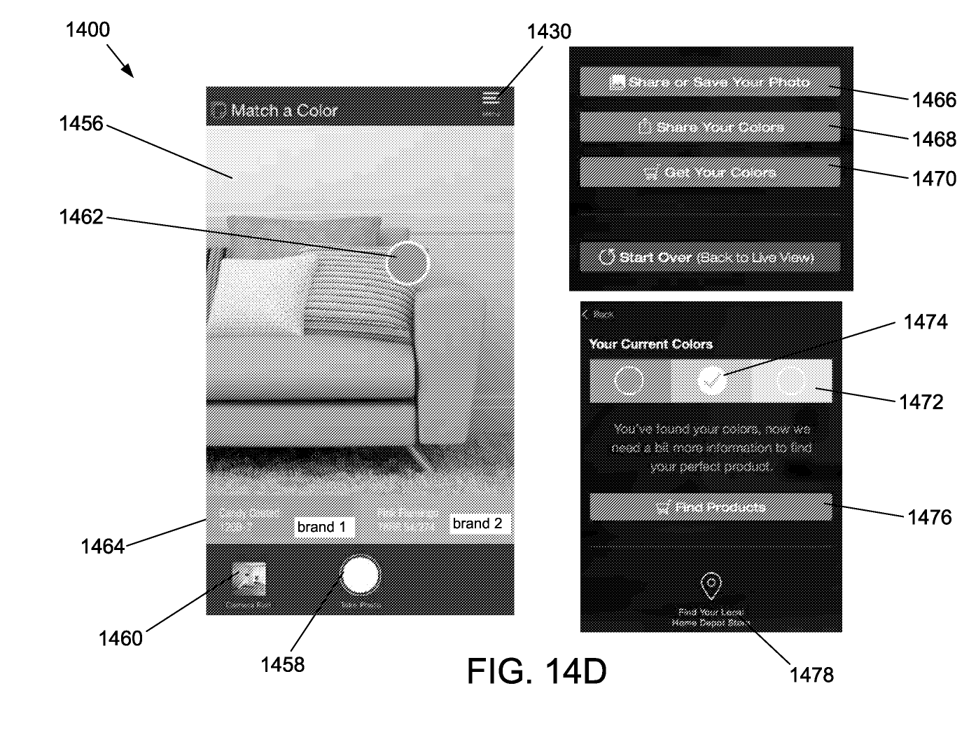

FIGS. 14A-14D illustrate exemplary embodiments of a mobile application exhibiting some or all of the functionalities described above. In some embodiments, a user may download the mobile application upon a selection of mobile application option icon 1202 shown in FIG. 12. In the embodiment shown in FIG. 14A, the user may access a mobile interface 1400 having a menu with a See It option icon 1402, a Match It option icon 1404, and a Find It option icon 1406. The functionality triggered by a user selection of See It option icon 1402 may allow the user to take and upload photos, access a live interactive interface, or access various mobile application tutorials. The functionality triggered by a user selection of Match It option icon 1404 may allow the user to match colors from an image or live view to colors of coatings stored in a coating database. The functionality triggered by a user selection of Find It option icon 1406 may allow the user to search for specific coatings via text search and/or hierarchical menu interfaces.

Upon a user selection of See It option icon 1402, the user may be presented with a live view option icon 1408, a photo taking option icon 1410, a photo loading option icon 1412, and an application tour option icon 1414. The functionality triggered by a user selection of live view option icon 1408 may allow the user to access a real time view of a particular environment such an interior room or exterior scene captured by a camera of the mobile device. The user may perform various actions on the live view such as analyzing objects for color matching or masking portions of the displayed environment with colors from a color database. The functionality triggered by a user selection of photo taking option icon 1410 may allow the user to take a still photo of a particular environment using a camera of the mobile device. The taken photo may be stored locally or remotely. The functionality triggered by a user selection of load photo option icon 1412 may allow the user to load a still photo stored in a database or memory. The loaded photo may be stored locally or remotely. The user may perform various functions on the taken or loaded photo as described herein. The functionality triggered by a user selection of application tour option icon 1414 may allow the user to tour the application and access helpful demonstrations, tutorials, and instructions.

In the embodiment shown in FIG. 14B, the user may search for coating products in various ways. In the embodiment shown, the user may select a search category from menu 1416. The functionality triggered by a user selection of menu 1416 may allow the user to search coatings by type (e.g., paint, stain, etc.), by text search or bar code scan, by recently viewed coatings, and other various methods. In the embodiment shown, a user may search for paint products by selecting a paint option from menu 1416 and access hierarchical menus similar to those described above. In the embodiment shown, the user may be presented with a color array similar to that shown in FIG. 3B, having color shades 1418 and text 1420 corresponding to a color family. Upon selection of a color family by the user, the user may be presented with options similar to those shown in FIGS. 4C and 6B. In the embodiment shown, the user may also search for specific coatings by entering text search terms into text box 1422 or scanning a barcode of a coating product. Results of the text search or barcode scan may be presented to the user. For example, if the user searches for “Reds,” the user may select various result sorting icons 1424 to sort the results in a desired manner. In the embodiment shown, paint results may be displayed with color shades 1425 and a corresponding description 1426. In the embodiment shown, description 1426 includes a paint color name and a brand name. By selecting a coating product, the user may be directed to a coating of a particular color and brand. In some embodiments, the user may use this color to modify a photo or live scene. Similar functionality may be performed by selecting other options from result sorting icons 1424.

In the embodiment shown in FIG. 14C, the user may modify a photo or live image in various ways. In the embodiment shown, the user is presented with a file options menu 1428 and a dropdown navigation menu 1430. In the embodiment shown, the functionality triggered by a user selection of file options menu 1428 may allow the user to undo editing actions, close an image, and save and/or share an image. The functionality triggered by a user selection of dropdown navigation menu 1430 may allow the user to navigate to other interfaces of the mobile application such as returning to one or more of the interfaces shown in FIG. 14A. In the embodiment shown, the user may be presented with multiple editing options 1432 and color options 1424, 1436. In the embodiment shown, editing options 1432 may include options to adjust image colors properties (e.g., brightness, hue, etc.) and sheens, display color details, remove and/or erase colors, adjust image brightness, compare images, and perform other functionalities disclosed herein. Color options 1434, 1436 may include colors selected by the user from searches performed in the interfaces shown in FIG. 14B. In the embodiment shown, the user may add additional color options by selecting an add color option 1438. In some embodiments, the user may return to interface 1400 shown in FIG. 14B to find and add additional colors. The user may use the colors shown in color options 1434, 1436 to modify the displayed image. For example, the user may want to paint a portion of the image one color and another portion of the image another color. In the embodiment shown, a paint roller icon may appear on a selected color option 1434 and distinguish the selected color from an unselected color option 1436. The user may then select a portion of the image to paint that portion in the selected color. In the embodiment shown, image portion 1440 is painted in the color of color option 1434 and image portion 1442 is painted in the color of color option 1436.

While myriad editing options 1432 are available, two are illustrated in the embodiment shown in FIG. 14C. A brightness option may be performed to illustrate how coating colors may look under various lighting conditions. In the embodiment shown, the user may modify a brightness of the image by moving a slider 1444 along a brightness scale 1446. In the embodiment shown, the brightness scale may contain intervals exhibiting the differences between daylight, LED light, and incandescent light. The color of painted portions 1440, 1442 may change to illustrate how the color will change under different lighting conditions. The functionality triggered by a user selection of an image compare option may be performed to compare an original image with a modified image. An original image may be a photo taken of a particular environment and a modified image may be a photo modified using one or more editing options 1432. The images may be stored and retrieved locally or remotely. In the embodiment shown, an original image portion 1448 may be displayed simultaneously with a modified image portion 1450. This feature may allow the user to compare different color, brightness, and coating options to the original image to see how the environment may look under many different conditions. In the embodiment shown, the user may determine the size of each image by moving a slider 1452 along a comparison scale 1454. In the embodiment shown, the comparison scale may contain intervals exhibiting more or less of the original image portion 1448 or the modified image portion 1452 based on the location of slider 1452 along the comparison scale 1454.

In the embodiment shown in FIG. 14D, interface 1400 may include a color match interface that may allow a user to select a portion of an image and receive recommendations of colors from a database that closely match the color in the image. In some embodiments, this functionality may be accessed upon a user selection of Match It option icon 1404 shown in FIG. 14A. Image 1456 may display a desired environment and may be accessed by taking a photo using a camera button 1458 or retrieving a stored photo by selecting a photo database option icon 1460. The images shown in the embodiment of FIG. 14C may be accessed in a similar way. In the embodiment shown, the user may touch image 1456 to select a paint match portion 1462. Paint match portion 1462 may correspond to a portion of the image exhibiting a color the user wishes to match. Upon a user selection of a paint match portion 1462, the system may search a color database and recommend colors that closely match the color shown in the paint match portion 1462. As discussed above, the color of paint patch portion 1462 may be determined by spectroscopic analysis. The closest color matches from the database may be displayed to the user via color product icons 1464. In the embodiment shown, color product icons display a color name, a color identification number, and a color product brand. The user may select color product icons 1464 to compare the selected color to the colors in the image. In the embodiment shown, paint match color portion 1462 may be colored in the color of the color product icon 1464 selected by the user.

In the embodiment shown in FIG. 14D, interface 1400 may also allow the user to save and share photos and colors as well as purchase color products. The functionality triggered by a user selection of share/save photo option 1466 may allow the user to save original and/or modified photos edited with one or more editing options. The functionality triggered by a user selection of share color option icon 1468 may allow the user to save/share colors chosen using the search options shown in FIG. 14B or matching colors recommended in color product icons 1464. The functionality triggered by a user selection of get color option icon 1470 may allow the user to find products matching the colors selected by the user and/or recommended to the user. Color option icons 1472, 1474 may be displayed to the user and may correspond to the colors previously selected by the user or recommended to the user. In the example shown, color option icons 1472, 1474 correspond to color options 1434, 1436 shown in the embodiments of FIG. 14C. The user may select a color option icon 1474 and select product purchase icon 1476 to access a purchase interface for purchasing various products having the selected color option. In some embodiments, the purchase interface may be similar to that shown in FIGS. 11A-F. In some embodiments, the user may select store location option icon 1478 to access a list of store locations where the desired coating products may be purchased. In some embodiments, the displayed locations may include inventory information to inform the user of products currently in stock.

In some embodiments, the system may provide tips from experts and/or associates at various steps throughout the method described above. These associate tips may provide advice tailored to the content the user is accessing. One example of an associate tip is shown in FIG. 3D. Other associate tips may be provided for other steps in the method. For example, if a user accesses the embodiment shown in FIG. 4C, an associate tip may be displayed that is relevant to one or more of the different shades of purple displayed. In one example, the associate tip may inform the user that longer drying times may be needed when painting with darker shades to avoid streaking, while shorting drying time may be used with lighter shades. In some embodiments, the associate tip may include a photo, name, and/or experience level of the associate giving the tip.

Although the embodiments disclosed above use certain interior paints and exterior coatings as an exemplary material coating, the embodiments disclosed above may also be applied to a plurality of material coatings such as other interior and exterior paints, interior and exterior stains, specialty finishes/coatings/varnishes, spray paints, small project/craft paints, waterproofers, sealants, and other material coatings. It may also be appreciated that the functions described above may be performed by multiple types of software applications, such as web applications or mobile device applications. If implemented in firmware and/or software, the functions described above may be stored as one or more instructions or code on a non-transitory computer-readable medium. Examples include non-transitory computer-readable media encoded with a data structure and non-transitory computer-readable media encoded with a computer program. Non-transitory computer-readable media includes physical computer storage media. A physical storage medium may be any available medium that can be accessed by a computer. By way of example, and not limitation, such non-transitory computer-readable media can comprise RAM, ROM, EEPROM, CD-ROM or other optical disk storage, magnetic disk storage or other magnetic storage devices, or any other physical medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above are also included within the scope of non-transitory computer-readable media. Moreover, the functions described above may be achieved through dedicated devices rather than software, such as a hardware circuit comprising custom VLSI circuits or gate arrays, off-the-shelf semiconductors such as logic chips, transistors, or other discrete components, all of which are non-transitory. Additional examples include programmable hardware devices such as field programmable gate arrays, programmable array logic, programmable logic devices or the like, all of which are non-transitory. Still further examples include application specific integrated circuits (ASIC) or very large scale integrated (VLSI) circuits. In fact, persons of ordinary skill in the art may utilize any number of suitable structures capable of executing logical operations according to the described embodiments.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the disclosed methods, devices, and systems are not intended to be limited to the particular forms disclosed. Rather, they include all modifications and alternatives falling within the scope of the claims, and embodiments other than those shown may include some or all of the features of the depicted embodiment. For example, components may be combined as a unitary structure and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A method of implementing an online coating material application, the method comprising:
initiating a session of an online coating material application by receiving a user input at a hardware device comprising at least one processor;
enabling the display on a user hardware device of one or more of a plurality of first selectable options comprising one or more of:
an interior coating exploration option;
an exterior coating exploration option; and
a project exploration option;
enabling the display on a user hardware device of one or more of a plurality of second selectable options comprising one or more of:
a color style option;
a color expert option;
a color purpose option;
a color room option;
a color object option; and
a color browse option;
receiving, at the hardware device, data representing a user selection of: one of the one or more first selectable options, or one of the one or more second selectable options;
enabling the display on a user hardware device of a hierarchical menu comprising selectable categories relating to the user selection;
receiving, at the hardware device, data representing a user selection of a category from among the selectable categories;
enabling the display on a user hardware device of one or more selectable material coating color options relating to the user selection of the category;
receiving, at the hardware device, data representing a user selection of one of the one or more selectable material coating color options;
enabling the display on a user hardware device of an image showing a sample environment coated in the selectable material coating color option selected by the user, the image being modifiable to change a material coating color based on a subsequent user selection of another of the one or more selectable coating color options; and
enabling the display on a user hardware device of a checkout link to the user that enables the user to purchase one or more material coatings corresponding to one or more of the one or more selectable coating color options.
